(19) United States
(12) Patent Application Publication
(10) Pub. No.: US 2006/0179418 A1
(43) Pub. Date: Aug. 10, 2006

(54) RESEARCH PROTOCOL TOOLKIT

(75) Inventor: Lawrence H. Boyd, Tempe, AZ (US)

Correspondence Address: SNELL & WILMER;ONE ARIZONA CENTER, 400 EAST VAN BUREN, PHOENIX, AZ, 85004-2202, US

(73) Assignee: PASADERO, INC., Tempe, AZ (US)

(21) Appl. No.: 11/275,980

(22) Filed: Feb. 8, 2006

Related U.S. Application Data
(60) Provisional application No. 60/650,829, filed on Feb. 8, 2005.

(51) Int. Cl. G06F 9/44

(52) U.S. Cl. 717/100

(57) ABSTRACT

Exemplary embodiments of the present invention comprise a tool kit for the design and execution of research protocols, for example, comprising a web-based research protocol composer for generating a data processing protocol; a collector for collecting data entered via an internet based questionnaire; a database for data; and a protocol processing routine for processing data and generating an output. For example, the toolkit suitably serves as a “hub” of a global research environment (e.g., connected via the Internet or other network) that creates and connects communities of researchers and facilitates the sharing of software and results. Additionally, the present invention provides standardized and custom online “programs” or “scripts” (referred to herein as “protocols”) that define and guide events in experiments, clinical trials, surveys, and other kinds of studies. These protocols are created and executed online.

### CROSS-REFERENCES TO RELATED APPLICATIONS

This application claims priority to U.S. Provisional Patent Application Ser. No. 60/650,829, filed Feb. 8, 2005 and entitled “Research Protocol Toolkit.”

### 1.1. FIELD OF INVENTION

This invention relates generally to an online universal access tool kit for researchers for the design and execution of research protocols. The invention also generally relates to an online data collection tool that automates the collection of data.

### 1.2. BACKGROUND OF INVENTION

Historically, there has been a fundamental disconnect between the process by which research software is designed and the process by which the software is actually “programmed.” Generally speaking, developing software for research is fundamentally an iterative process, sometimes even a process of successive approximation.

For example, the typical instruction from a researcher to a software engineer is “Please do X, Y, and Z.” Weeks later, researchers receive the software and try it only to discover that Z was not correctly understood or is not right for the researchers objectives. In response, the researcher asks the software engineer to “change Z to W.” Again, several more weeks later, the redesigned software is provided to the researcher and upon testing, the software does not work—it crashes or fails because the software engineer did not anticipate the effect of the change of “Z to W” throughout the code. Such an iterative process continues on until a sufficient program is developed—often and great cost and expense.

While generally it is desirable that the software engineers have the background and expertise of the researcher, or vice versa, the researchers have the expertise and background of software engineers, heretofore, neither scenario has been realistic.

Accordingly, a research protocol design and execution tool kit which assists users to build their own powerful, configurable, and recyclable research support applications is desirable, for example, by re-using existing research protocols, or creating new configurable protocols with menu-based composing operations.

### 1.3. SUMMARY OF INVENTION

While the way in which the present invention addresses the disadvantages of the prior art will be discussed in greater detail below, in general, briefly, the present invention is directed towards an online toolkit for the design and execution of research protocols and the collection of data. For example, various embodiments of the present invention provide the basic authoring tools needed for most types of research design.

As will become apparent herein, toolkits in accordance with the present invention provide, inter alia, an improved quality of scientific research, improved quantities of scientific research, increased availability and accessibility to scientific research, diversified and enriched content of scientific research, and increased efficiency of scientific research.

In this regard, toolkits in accordance with the present invention can be thought of as “process designers” created by researchers for the conduct of empirical research. For example, there are four major components to the “process” involved in conducting an empirical study, namely study design, data collection, data analysis, and dissemination.

Toolkits in accordance with the present invention provide software support for all four components, particularly in study design and data collection. As noted above, until now, software for research design and data collection has of necessity been largely the exclusive domain of programmers and custom software developers usually under outsourcing arrangements. Toolkits in accordance with the present invention diminish the effects of escalating costs of programming along with the exasperating problems of communicating with programmers.

However, data collection components of toolkits in accordance with the present invention may be distinguishable from other common uses of “data collection” components in that toolkit data collection is not merely the creation of data archives or systematic data input to an organizational information system. Rather, the data collection component of toolkits in accordance with the present invention involves systematic input of data that occurs during the actual conduct of specific research projects.

In this regard, data collection is connected to the study design based on being prescribed by the actual design of a study itself, and that data collection is initiated substantially every time a measurement event is encountered during the execution of the study (“measurement events,” as used herein, occur during the execution of a protocol and generate data).

In accordance with the present invention, measurement events vary depending on research method and design and the “instruments” used to make the measurements. For example, measurement instruments used in a survey are typically questionnaires. The instruments used in human performance studies might involve ringing a bell, clicking on a moving target, or the electronic tracking of eye movements. The instruments in a clinical study might involve a blood sample, MRI imaging, or a hearing test, and the instruments used in a qualitative research study might involve recording verbal behavior or observations. All of these produce data and can be thought of as different types of data collection.

Toolkits in accordance with the present invention thus provide novel implementations of new and existing data collection instruments, which suitably provide the ability to ensure the quality of data collected. Likewise, as described in more detail below, large numbers of shared protocols developed in accordance with the present invention and potentially available in a “public library” enable author/designers to see how concepts were measured in other studies and to borrow and modify them in much neglected replications of studies.

Moreover, toolkits in accordance with the present invention provide consistency—and corresponding quality—in data collection. As those skilled in the art appreciate, an important dimension of data quality is measurement reliability, which means that repeated measurements using the same instruments (like a questionnaire) will produce the same results (data). This is sometimes called measurement consistency.

There are three ways that data can be internally inconsistent. The first way is for an instrument itself to change from one presentation to another. For example, manually written instructions to interviewers may become corrupted during the research process. However, as will become apparent, the electronic presentation of measurements by toolkits of the present invention remedies this problem. The second way that data can be of poor quality due to internal inconsistency is when research staff presents measurements differently from measurement to measurement and subject to subject. In contrast, the automatic presentation of measurements by toolkits of the present invention remedies this problem.

A third way that data can be internally inconsistent is through errors in the transcription of measurement results into data files. Errors in transcription are both random and systematic.

Random errors are as likely to be in one direction as another. Systematic errors tend to be “biased” in one direction. Toolkits such as these herein provide substantially automatic transcription of results, eliminating this problem.

Still, another major source of poor data quality is missing or incomplete data. One source of missing data is the failure of data collectors to get the information called for by the instrument. This can be due to poor training or the lack of supervision. However, toolkits of the present invention provide instant data storage as sessions are conducted and may also provide summary data on the collection process itself.

Thus, regular feedback and automatic analysis of responses can be built into a toolkit protocol to tell each data collection person how he or she is doing on getting the targeted data.

Such feedback is often itself enough to correct the problem of missing data of this kind. When it is not, the same collection process data can be used by supervisors to detect potential problems with individual data collectors, sometimes calling for corrective actions, such as additional training, greater supervision, and change of data collection personnel.

Another major cause of bad data can emerge when subjects self-administer their own treatments and measurements and do not comply with prescribed regimens. Noncompliance with prescribed regimens can be a matter of great concern about the quality of data in clinical trials or studies that use similar data collection processes.

For example, a subject may be expected to take a certain medication of a certain dosage every day at the same time and then fill in an entry to a questionnaire about other daily activities and symptoms and then make an entry into a daily or periodic log. In many cases, the subject forgets or simply neglects to follow the prescribed regimen. The toolkits described herein solve this problem by enabling the principle investigator to write into a protocol the detection of non-compliance and notification to that effect the next time that the subject opens his/her log. Often, this is enough to improve the quality of data in these studies. However, non-compliance can also be detected by caseworkers or study supervisors at any computer that has Internet access. The caseworkers or study supervisors can then speak with the subjects who are having difficulty following the prescribed regimen and resolve the problem or remove the subject from the study, giving the reasons why.

Now, with more particular regard to the toolkit and the considerations above and discussed elsewhere herein, exemplary embodiments of the present invention comprise a tool kit for the process design and execution of research protocols, for example, comprising a web-based research protocol composer for generating a data processing protocol; a collector for collecting data entered via an internet based questionnaire or other measurement instrument; a database for storing data; and a protocol processing routine for processing data and generating an output.

For example, in various exemplary embodiments, the toolkit suitably serves as a “hub” of a global research environment connected via the Internet or other network-that creates and connects communities of researchers and facilitates the sharing of software and results.

Additionally, in various embodiments, the present invention provides standardized and custom online “programs” or “scripts” (referred to herein as “protocols”) that define and guide events in experiments, clinical trials, surveys, and other kinds of studies. These protocols are created and executed online. An exemplary “help file” for an embodiment of a toolkit in accordance with the present invention can be found at www.protogenie.com/February1HTMLHelpfolder/HelpfileHomePage.htm, the content of which is herein incorporated by reference.

Moreover, additional advantages of the present invention may become apparent such as the reduction of costs of research and related software, for example, by eliminating highly specialized coding and one-time use programs.

### 1.4. BRIEF DESCRIPTION OF DRAWINGS

Exemplary embodiments of the present invention will be described or illustrated in connection with the appended drawing figures, where:

FIG. 1 is a process flow diagram in accordance with an embodiment of the present invention;

FIG. 2 is a client side process flow diagram in accordance with an embodiment of the present invention;

FIG. 3 is a screenshot illustrating interactions in the developer's web environment in accordance with an embodiment of the present invention;

FIG. 4 is a screenshot illustrating interactions in the author/designer's web environment in accordance with an embodiment of the present invention;

FIG. 5 is a screenshot illustrating interactions in the end-user's web environment in accordance with an embodiment of the present invention;

FIG. 6 is a screenshot illustrating data analysis in the principle investigator's web environment in accordance with an embodiment of the present invention;

FIG. 7 is a server side process flow diagram in accordance with an embodiment of the present invention;

FIG. 8 illustrates a typical description window for a protocol in accordance with an embodiment of the present invention;

FIG. 9 is a screenshot illustrating a start up alternatives page in accordance with an embodiment of the present invention;

FIG. 10 is a screenshot illustrating a typical personal library page in accordance with an embodiment of the present invention;

FIG. 11 is a screenshot illustrating a search page, including an option to search a general library in accordance with an embodiment of the present invention;

FIG. 12 is a screenshot illustrating a typical user action links page in accordance with an embodiment of the present invention;

FIG. 13 is a screen under a make and edit groups tab of an edit protocol page in accordance with an embodiment of the present invention;

FIG. 14 is a screen under a make and edit events tab of an edit protocol page in accordance with an embodiment of the present invention;

FIG. 15 a screen under a sequencing tab of an edit protocol page in accordance with an embodiment of the present invention;

FIG. 16 is a screenshot illustrating a typical execution results page in accordance with an embodiment of the present invention; and

FIG. 17 is a screenshot illustrating an exemplary screenshot of a database in accordance with an embodiment of the present invention.

### 2.0 DETAILED DESCRIPTION

The following descriptions are of exemplary embodiments of the invention only, and are not intended to limit the scope, applicability or configuration of the invention in anyway.

Rather, the following description is intended to provide convenient illustration for implementing various embodiments of the invention. As will become apparent, various changes may be made in the function and arrangement of the elements described herein without departing from the spirit and scope of the invention. For example, though not specifically described, various research tools and methods may be utilized by way of the functionality of the present invention and thus, should be understood to fall within the scope of the present invention.

### 2.1. OVERVIEW OF THE INVENTION

As summarized above, toolkits in accordance with the present invention are “process designers” created by researchers for the conduct of empirical research. In the context of the present invention, when used herein, “researchers” comprise anyone involved in the four components of scientific research, namely study design, data collection, data analysis, and dissemination. Scientific research processes (or simply research processes) as referred to herein are specified sequences or series of continuous operations, activities, actions, changes, or functions, involving people, systems, objects, techniques, methods, and particular courses of action executed to acquire knowledge aimed at explaining phenomena and making predictions.

Toolkits in accordance with the present invention, provide software support to the four components of the “process” of conducting an empirical study, particularly with respect to study design and data collection. Specifically, data collection components of toolkits in accordance with the present invention involve systematic input of data that occurs during the actual conduct of specific research projects by connecting data collection to the study design itself and by initiating data collection substantially every, if not every time, a measurement event is encountered during the execution of the study.

Additionally, toolkits in accordance with the present invention provide novel implementations of new and existing data collection instruments, which suitably provide the ability to ensure the quality of data collected. Likewise, large numbers of publicly shared protocols available in a public protocol library or database enable author/designers to see how concepts were measured in other studies and to borrow and modify them in much neglected replications of studies.

That being said, exemplary embodiments of the present invention comprise a tool kit for the process design and execution of research protocols, for example, comprising a web-based research protocol composer for generating a data processing protocol; a collector for collecting data entered via an internet based questionnaire or other measurement instrument; a database for storing data; and a protocol processing routine for processing data and generating an output.

With these aspects and as used in practice, toolkits in accordance with the present invention suitably serve as the aforementioned “hub” of a global research environment (e.g., connected via the Internet or other network) that creates and connects communities of researchers and facilitates the sharing of software and results. These protocols are created and executed online.

Moreover, additional advantages of the present invention may also become apparent such as the reduction of costs of research and related software, for example, by eliminating highly specialized coding and one-time use programs.

In general, in accordance with various exemplary embodiments of the present invention, a toolkit for the design and execution of research protocols is provided. In various embodiments and as mentioned above, the toolkit suitably serves as a “hub” or center of a research environment (e.g., connected via the Internet or other network) that creates and connects communities of researchers and facilitates the sharing of software and results. Additionally, in various embodiments, the present invention provides standardized and custom online “programs” or “scripts” (referred to herein as “protocols”) that automate the collection of data and define and guide events in experiments, clinical trials, surveys, and other kinds of studies.

For example, a toolkit in accordance with an exemplary embodiment of the present invention comprises a web-based system containing an online composer/editor that suitably creates executable computer programs (OECP), preferably online OECPs. In such embodiments, OECPs suitably define and control events, group strategy, intervention, measurement, sequencing, the collection of data and other rules, in scientific experiments as well as other research.

Through the use of on-line or web-based application, researchers are liberated from expensive shrink-wrapped applications and irritating and distracting self-maintenance and upgrades. It uniquely provides universal access independent of equipment and operating systems. It provides a standard and familiar user interface and an open architecture consistent with the philosophy of the toolkit. It provides for an integrated researcher forum and an integrated help system. By the very nature of the Internet, implementation online fosters the decentralization of research and encourages small science as a remedy to monopolized science. Last, its Web-centric application easily supports on-line studies, such as on-line surveys and on-line experiments.

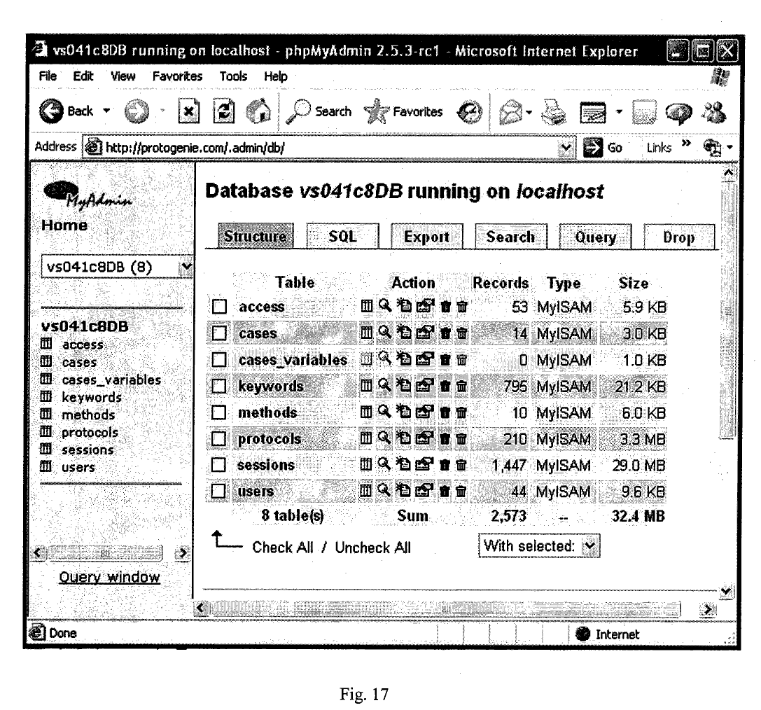

Additionally, systems in accordance with the present invention further comprise a database structure, preferably web-based, that stores OECP programs and data produced by the execution of OECP programs. For example, with brief reference to FIG. 17, programs such as phpMyAdmin (some of which may be shareware or freeware) may be used to create and maintain such databases.

### 2.2. TOOLKIT COMPONENTS

Toolkits in accordance with the present invention are preferably configured as “generic,” “web-based” research (e.g., scientific) process designers, binary encoders, and executors. “Generic” refers to the basic design of toolkits described herein that supports what is common (universal) to all scientific research designs and execution processes, including experiments, clinical trials, surveys, and other kinds of studies and designs. “Web-based” refers to the fact that toolkit protocols developed and executed in accordance with the present invention may be performed using standard Internet servers and browsers.

The computer-assisted process designers included in toolkits of the present invention are preferably web-based (online). Such process designers suitably comprise any computer authoring system suitable for use in the creation of custom computer software that enables and supports the aforementioned design, encoding, and execution of scientific research processes and unlike known data analysis and statistics software for research. Preferably such authoring systems are readily and easily used by researchers and are specifically used or adaptable for online research design and data collection. For example, authoring systems such as Flash, Java Script, MySQL, HTML, XML, PHP and other suitable web tools, now known or as yet unknown may used in accordance with the present invention.

Toolkits in accordance with the present invention also suitably include binary encoders comprising a collection of selected web-based tools that convert an author's menu choices, execution specifications, imported software, and other research language inputs into instructions on a local computer and on a toolkit web server to support the process designer and to support various research processes made possible through use of toolkits of the present invention.

Toolkits in accordance with the present invention further suitably include composers/editors, as either separate and distinct components or combined, that function as authoring programs for creating the protocols that guide research processes and collect data for analysis and dissemination. In general, the composer/editor allows and/or facilitates defining groups, defining measurement, treatment, and support events, and defining the order of execution of the events. As described later herein, protocols may be brand new and/or may be made by customizing existing protocols.

### 2.3. TOOLKIT PROCESSES AND INFORMATION FLOW

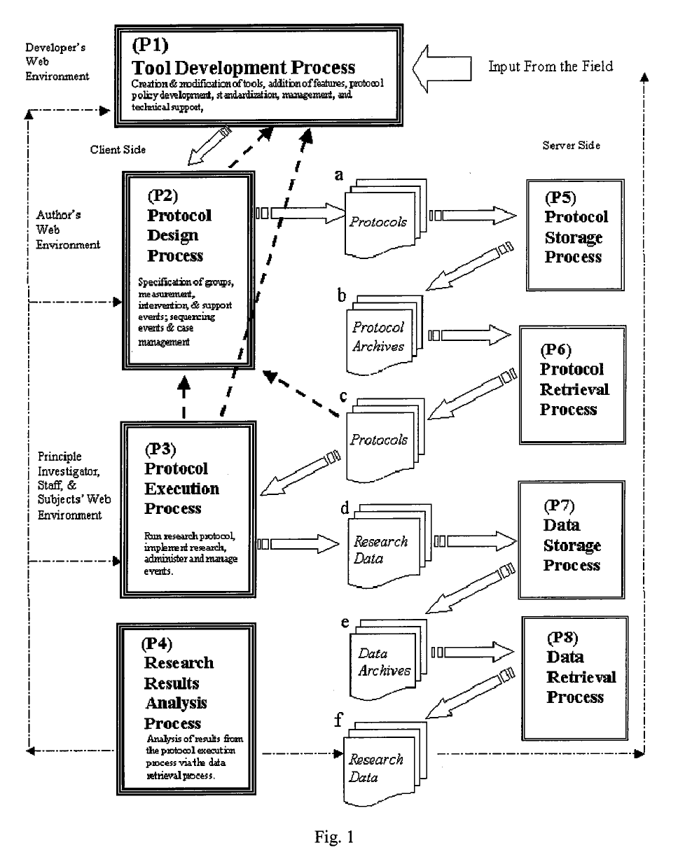

According to various preferred embodiments of the present invention, toolkits described herein are made up of a total of eight interconnected processes, four of which are on a client side and four on a server side. For example, FIG. 1 illustrates a full view of the eight interconnected toolkit processes showing the flow of information connecting them as well as feedback connections shown with dotted lines therebetween. The client and server side processes are described in detail below.

### 2.3.1 CLIENT SIDE PROCESSES

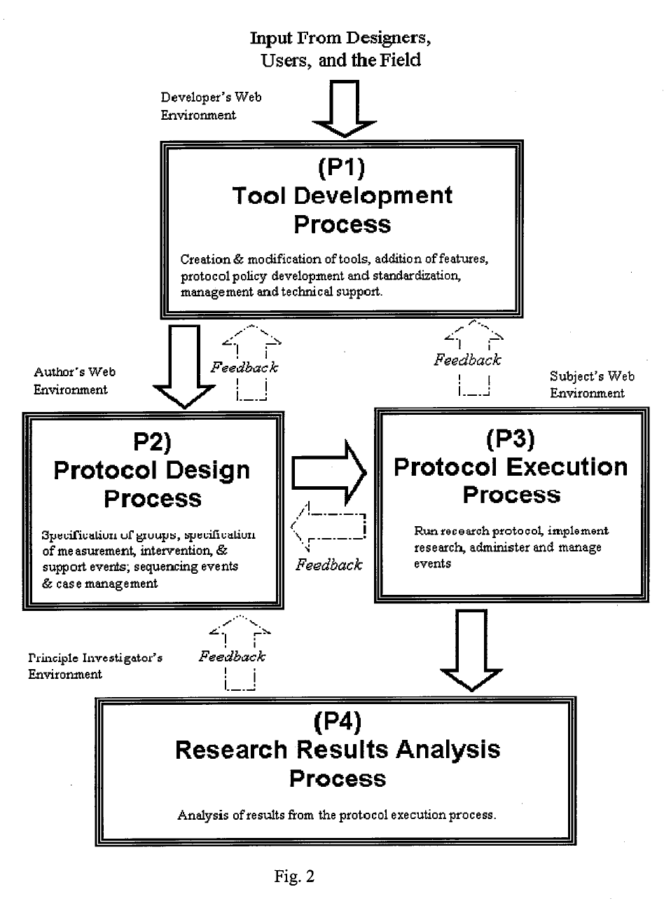

The four, preferably interrelated, client side processes present in accordance with exemplary embodiments of toolkit (illustrated in the schematic of FIG. 2) are tool development (P1); protocol design and development (P2); protocol execution (P3); and data analysis and reporting (P4).

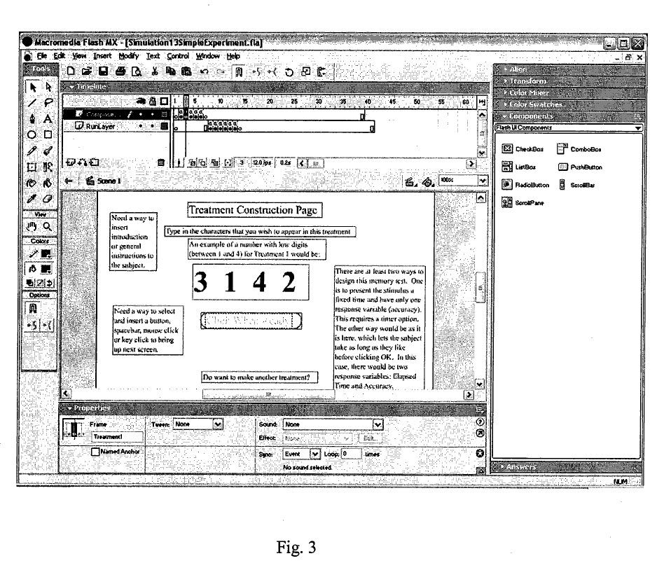

In the presently described embodiment of the invention, the tool development process takes place in the developer's web environment where authoring tools, features, equipment interfaces, and user interfaces are created, tested, and modified, and where protocol policy is made and standards are set, and where user and technical documentation is created and technical support is provided. For example, a typical screen with which a developer interacts is shown in FIG. 3 illustrating interactions in the developer's web environment. Because of online access to designated developers, the developer's environment thus may be either narrowly localized or globally distributed.

Information flows from author/designers and from the field into the tool development process and from the tool development process (P1) to the protocol design process (P2). As illustrated by the schematic of FIG. 2, information emerging in the protocol design process (P2) and the protocol execution process (P3) also feeds back to the tool development process (PI).

The protocol design and authoring process takes place in an author/designer's web environment. An author/designer's environment is distinguished from the developer's environment and the end-user's environments because it involves accessing the composer/editor and using it to design and create protocols for the execution of research. “Protocols” are detailed plans for a scientific experiment or treatment. More specifically, a protocol is a set of instructions to guide the conduct of an experiment. The toolkit automates protocols so that the computer will administer and record experimental sessions effectively, accurately, and reliably.

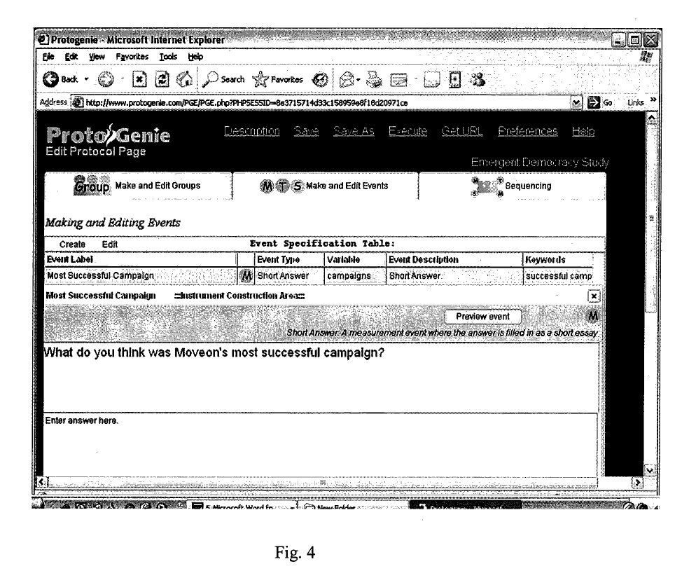

A typical screen with which an author/designer interacts in the creation and editing of protocols is shown in FIG. 4. This screen shows a shot of the composer/editor showing the three major actions in protocol construction, creating groups, creating events, and sequencing them within group. Operations in the design/author's environment typically involve the definition of groups, measurements, interventions, the sequencing of these events, and case management.

As illustrated by the schematic of FIG. 2, information flows from the tool development process (P1) into the protocol design process (P2) and from the protocol design process (P2) to the protocol execution process (P3). Information emerging in the protocol execution process (P3) also feeds back to the protocol design process (P2).

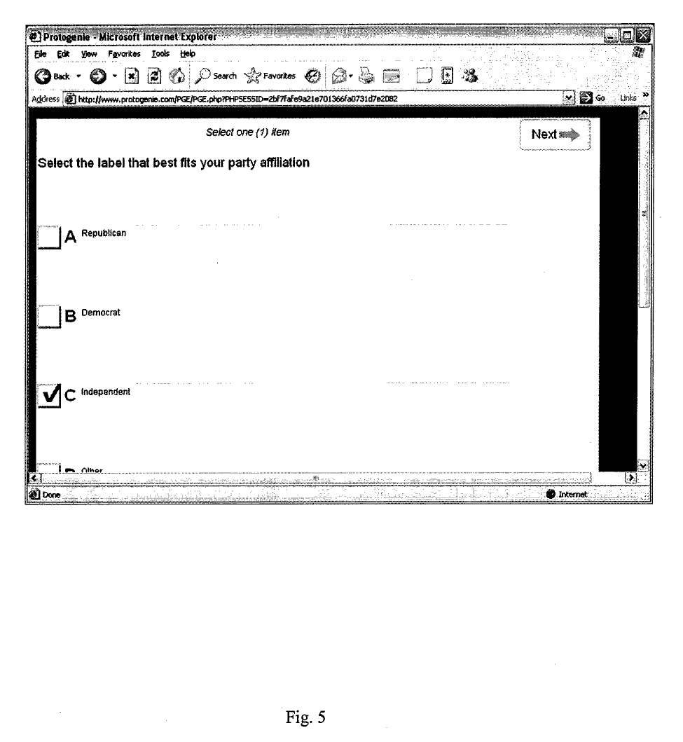

The protocol execution process takes place in the end-user's environment. The end-user's web environment involves session conductors, subjects and respondents in studies, and protocol testers, who are involved in the running of research protocols and who generally do not participate in the development of the toolkit or have access to the composer/editor. A typical screen with which an end-user interacts is shown in FIG. 5. This screen shows a typical measurement event, in this case, asking a respondent for his/her political party affiliation. Because protocols are executed online and can be accessed from a standard computer and Internet connection, the user environments can be narrowly confined by location or globally distributed.

As illustrated in FIG. 2, information flows from the protocol design process (P2) into the protocol execution process (P3). Feedback from the protocol execution process (P3) back to the protocol design process (P2) comes in the form of changes through design and testing iterations. Feedback to the tool development process (P1) comes in the form of requests for fixes, new features, and modifications.

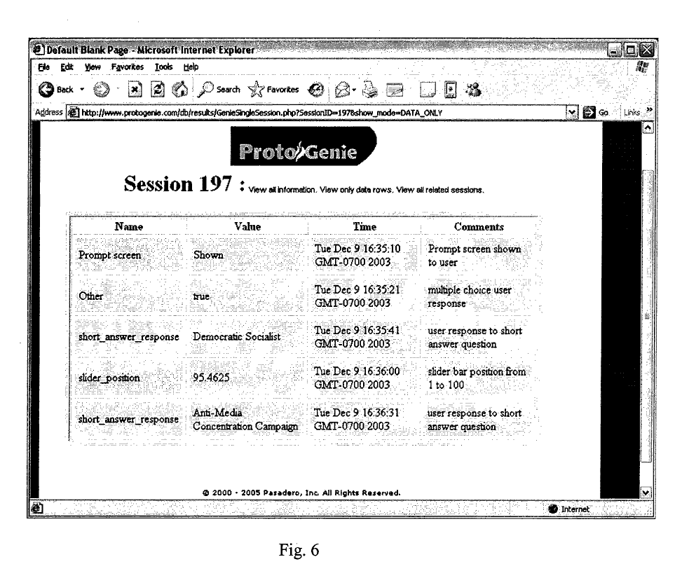

The research results analysis and reporting process takes place in the principle investigator's environment. The principle investigator's environment involves the individuals who are responsible for the design and execution of a research project, including the analysis of the data and often the dissemination of results. Principle investigators may or may not be primary protocol author/designs. A project may have one principle investigator or many working as a team. A typical screen with which a principle investigator interacts is shown in FIG. 6. This screen presents the results of a typical execution of a protocol.

Because protocols are executed online and can be accessed at any standard computer and Internet connection, the principle investigator's environments can be locally or globally distributed. Consequently, highly collaborative projects such as surveys can be carried out in cities and other localities worldwide.

Analysis of research data often leads to study replications and new research which in turn leads to the creation of new protocols and to requests for new and modified features. For example, in FIG. 2, this is represented by the dotted lines flowing from the analysis process (P4) back to the execution process (P3), the design process (P2), and the tool development process (P1).

### 2.3.2 SERVER SIDE PROCESSES

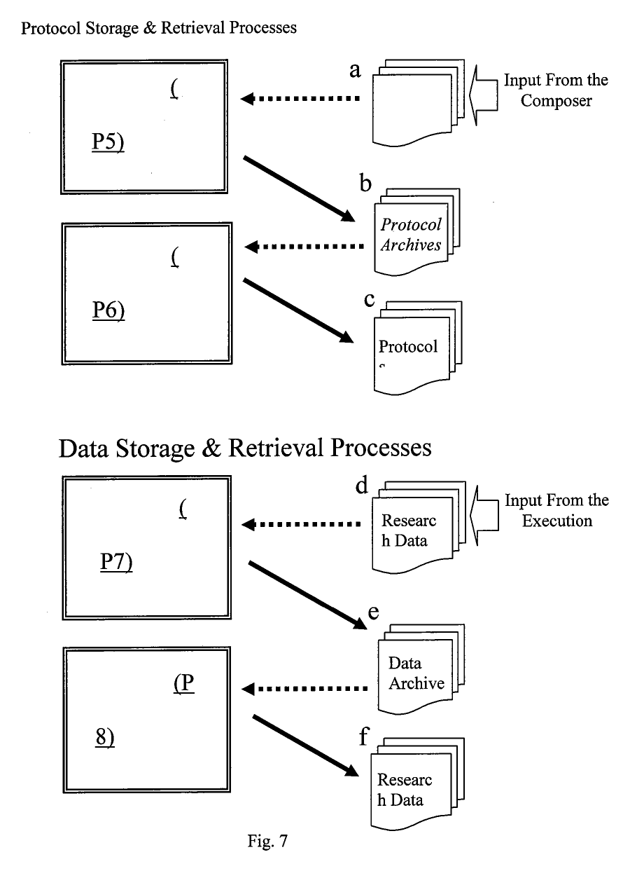

The four interrelated server side processes present in accordance with exemplary embodiments of toolkit (illustrated in the schematic of FIG. 7) are protocol storage (P5); protocol retrieval (P6); data storage (P7); and data retrieval (P8).

On the server side, toolkits in accordance with the present invention preferably comprise two major processing systems involving storage and retrieval. The first involves output from the toolkit protocol design process (P2) in the form of protocols. The second involves output from the toolkit protocol execution process (P3) in the form of research results (data).

In various exemplary embodiments of the toolkit, the protocol storage process (P5) inputs protocols (a) from the protocol design process (P2) and stores it in protocol archives (b) in server storage. Any now known or as yet unknown storage medium may be used in connection with the present invention.

The protocol retrieval process (P6) inputs protocols from server archives (b) and sends them in the form of protocols (c) to client side processes for modification or execution. Feedback from the protocol retrieval process (P6) to the protocol design process (P2) via output (c) takes the form of typical design protocols and third party protocols for use as templates. The data storage process (P7) inputs research data (d) from the protocol execution process (P3) and sends the data to data archives (e) on the server. The data retrieval process (P8) inputs data from data archives (e) on the server and sends the data (f) to the results analysis and reporting process (P4) on the client side for analysis and reporting.

### 2.4. PROGRAMMING OF AN EXEMPLARY EMBODIMENT

A system for the design and execution of research protocols in accordance with the present invention is preferably web-based. In this regard, Hypertext Markup Language (HTML) and JavaScript are currently preferable, well known, web development tool for the framework of such a system, though one skilled in the art will appreciate that various web development tools and languages now known or as yet unknown in the art may suitably fall within the scope of the present invention.

In the presently described embodiment, protocols and data gathered during the execution of those protocols are preferably stored in Extensible Markup Language (XML) format offering advantages such as allowing organization of data in a manner generally easily readable for both computers and humans.

Additionally, in this embodiment, data generated in XML format is suitably stored in a database, preferably a standard language database such as Structured Query Language (SQL) (e.g., MySQL).

In accordance with another aspect of the present invention, dynamic content is created, for example, using PHP (Hypertext Preprocessor) or another open source language. After logging into the system, basic management tasks, such as viewing protocols or searching through available protocols, is accomplished by accessing web pages that use PHP scripts. “Dynamic content” in this context means bringing up the same page, but one that looks different to different people.

Examples of dynamic content include such things as search results in Google or a shopping page in Amazon.com. In effect, these pages are created “on-the-fly,” based on search terms that the user specified on the previous page. When author/designers log into the toolkit, they do the same sort of thing. For example, they specify who they are and the server creates a web page showing their own personal protocols. That specific rendition of the web page was created dynamically by a PHP script. No special tools are needed to write PHP scripts, but a web server has to be configured to use it. There are other tools that could have been used to create dynamic pages, in the presently described embodiment, PHP is preferable as it is completely open source and because most hosting companies do not charge extra for supporting it.

In the presently described embodiment, Flash was selected as the core Web page programming environment for the toolkit because of its many strengths, including ease of use, robustness, and powerful animation capabilities. Animation may be especially important in the vision and cognitive sciences where complex visual stimuli are presented to subjects. For example, Flash is used in two places during the development of the research support software toolkit. It is used when author/designers define (set up) protocols and it is used again in the execution or run time of a protocol.

The communication between the client and the server and the relationship among these development languages is typified by the following cycle. An author/designer logs in and requests a particular protocol via standard PHP/HTML login interface. He is redirected to a PHP-based page that hosts the Flash movie. The Flash movie determines which protocol was requested based on its launch parameters. The Flash movie makes HTTP request to a PHP script on the server, requesting the protocol. PHP script accesses the MYSQL database. MySQL database sends protocol back to PHP script in the form of XML text. PHP script sends XML text back to the Flash movie. The Flash movie converts XML text into a more user-friendly description of the protocol. The Flash movie presents the toolkit user interface that allows the author/designer to edit the protocol.

Because it is in their best interest to have Flash be a universal component in every web browser, Macromedia gives it away and makes it easy install. Statistics suggest that the Flash Player is the single most common Plug-in on the web. Unlike the other web development tools used for the toolkit, one cannot edit the Flash code using free tools. The only way to edit a Flash movie is to use the program that Macromedia licenses or sells. Macromedia makes no claim to ownership of anything created by Flash, the source code can be opened at no charge if desired, but the Flash parts of the toolkit cannot be edited without Flash. Of course, one skilled in the art will appreciate that in the future, Flash movies may be replaced with the executables of a different technology that is more powerful and ideally open source.

An important aspect of the toolkit itself is the XML/MySQL/PHP design that is used to create protocols and session data. As described hereinbelow, the protocols themselves that are used to specify and execute studies may or may not be unique. Therefore, a benefit of the toolkit in accordance with the present invention is the ability to exploit the Webcentric architecture of the toolkit to design and develop protocols in ever expanding areas of specialized research.

In its various embodiments, the toolkit supports the capability to run programs within Flash movies that are written in Web-friendly versions of standard programming languages, such as Microsoft's C# (C sharp), Java applets, or Flash. That is, these programs generally must be able to run inside a web page. The toolkit documentation and help files provide step-by-step instructions for how to set up external software to import to the toolkit, including, preferably, example code. An example of the need for this capability would be in the presentation of complex visual stimuli in vision and cognitive science. The toolkit strongly recommends that such applications provide user-friendly menu-based options for customizing these programs for non-programmer needs and provide guidelines for doing so.

Thus, numerous benefits are achieved, including the ability to design and build individual research software by tapping vast pools of subjects with experiments online, to conduct field studies using wireless notebooks, to conduct studies in several cities around the globe, to interface with external equipment and software, to enrich campus and university computer support programs, to support a science and methods curriculum, to connect anywhere on any system, and to obtain help on design questions. With code sharing, online application enables distributed toolkit development as in massively parallel debugging, feature extensions and field specialized applications.

Thus, toolkits in accordance with the present invention provide universal access online for scientists and researchers of all fields and methods, evaluators, practitioners, other professionals, teachers and students for the design and execution of online research protocols and data collection. The toolkit has the authoring tools needed for most types of research design. Situated solidly online, the toolkit is the hub of an evolving global research environment that creates and connects communities of researchers and facilitates the sharing of software and results. The toolkit may also reduce the costs of research software by eliminating highly specialized coding and calcified one-shot programs. Moreover, the toolkit's friendly and intuitive interface is grounded in the logic of scientific method and the familiar look and feel of the Web. Such benefits enable programmers and non-programmers alike to build powerful, configurable, and recyclable research support applications at radically lower costs.

Anyone, programmer and non-programmer who can operate a computer and has an Internet connection and access to a computer with average power and memory is able to use the toolkit. For example, in a preferred embodiment the computer used has a Windows, Linux or Macintosh based operating system, a Pentium 2 or Mac OS processor or greater, a high speed internet connection, the Flash 6 Plug In, the Java Plug In and Internet Explorer v5.5 or higher.

Online application liberates researchers from expensive shrink-wrapped applications and irritating and distracting self-maintenance and upgrades. It uniquely provides universal access independent of equipment and operating systems. It provides a standard and familiar user interface and an open architecture consistent with the philosophy of the toolkit. It provides for an integrated researcher forum and an integrated help system. Also, by the very nature of the Internet, implementation online fosters the decentralization of research and encourages small science as a remedy to monopolized science.

### 2.5. USES OF INVENTION

### 2.5.1. SUMMARY OF USES

The toolkit may be used to bring scientific method and research design to classrooms. At the college level, the toolkit may be integrated into scientific methods curricula. In statistics courses, the critical connection between study design and statistical analysis may be made using the toolkit. Additionally, the toolkit may be used to stay abreast of current research in various fields and topics of interest, to share software and results, and to communicate with other researchers about problems, solutions, and potential collaboration

Virtually all universities have a campus or statewide computer support facility. Some of these facilities are now offering services involving computerized research methods, such as computer-assisted survey technology. But, few, if any, provide any support for computerized control group experiments, clinical trials, psycho-physiological research, and other research and evaluation methods. The online accessibility of the toolkit makes it an ideal facility for students and faculty at these institutions. The toolkit can help students design and create software for their term projects and theses. It can be used in statistics courses to design real studies and create data sets to statistically analyze and it can be used in classes across the board to help make the connection between theory and research and theory and practice.

With the toolkit's easy availability and powerful tools will come opportunities to develop libraries of protocols for specific departments and fields. For example, potential protocols include empirical research and expert systems to assist in decision-making.

### 2.5.2. EXEMPLARY TYPES APPLICATIONS

Classical experiments seek to measure the causal effects of treatment variables on response variables through random assignment of subjects to experimental groups and through the manipulation of the treatment variables; sometimes referred to as “laboratory experiments” because of the high degree of control over settings and are commonly used in psychology and related disciplines and in clinical settings, law and other professions. Studies that do not permit high levels of control are generally known as “quasi-experiments” and are generally used in field settings such as schools and other institutions.

Classical experiments create situations as close to real as possible. Quasi-experiments compensate for lack of controls through matching, presentation and removal of treatments, and statistical analysis. An example of an application of the toolkit for a classical experiment in vision science is the study of the effects of different types of room illumination and wall coloring on reading performance.

Clinical trials are studies that follow selected individuals forward in time from a pre-set baseline, some receiving an intervention and some not. Typically, such studies measure the effects of medical interventions, including therapeutic agents, devices, regimens, and procedures. They are most commonly used in medical, pharmaceutical, and public health research. A major part of the design of clinical trials is usually the provision of mechanisms and procedures for maximizing and assessing “compliance,” as in taking a medication daily in the prescribed amount at the prescribed times. An example of an application of the toolkit in clinical trials in vision science is a test of the efficacy of sustained-release, intraocular implants that deliver ganciclovir in the treatment of cytomegalovirus retinitis in patients with the acquired immunodeficiency syndrome (AIDS). Typically, this study would involve one or more control groups that receive another intervention or a placebo.

Laboratory trials typically involve repeated presentations of stimuli (interventions or treatments) and measurements (trials); such trials often use equivalent materials to control the effects of memorizing. Stimuli are often presented on visual and auditory devices and are commonly used in vision, cognitive, and human performance research. Laboratory trials are also used in materials research and testing. Examples include testing the effects of colored text and backgrounds on reading speed and comprehension and testing the effects of distracters on target detection and recognition.

An industrial example might test the effects of variable temperatures on the properties of a material or product. An example of laboratory trials research in vision science might involve the repeated presentation of 19 smiling faces and 1 frowning face with random placement on a computer display with the objective of measuring the effects of distracters on the detection and location of an object in a visual space.

In the most preferred embodiments, the toolkit is a worldwide network or “research environment” of author/designers brought together online (e.g., through protocol sharing, user forums and the like) to share software and information and to reduce dependence on software engineers and costly fixed applications. As such, the toolkit environment is designed to grow and evolve with universal access and open source tools. That is, the toolkit treats protocols as research capital to be exploited, not wasted.

Exemplary research methods used in accordance with the present invention are categories of terminologies, strategies, and techniques that are used to conduct research. For example, a preferred embodiment of the toolkit supports six such categories or methods: Classical & Quasi Experiments, Clinical Trials, Laboratory Trials, Survey Research, Qualitative Research, and Combined Methods Research.

### 2.5.3. APPLICATION EXAMPLES

An example of an application of the toolkit for a classical experiment in vision science is the study of the effects of different types of room illumination and wall coloring on reading performance. An example of an application of the toolkit in clinical trials in vision science is a test of the efficacy of sustained-release, intraocular implants that deliver ganciclovir in the treatment of cytomegalovirus retinitis in patients with the acquired immunodeficiency syndrome (AIDS). Typically, this study would involve one or more control groups that receive another intervention or a placebo.

Examples of laboratory trials include testing the effects of colored text and backgrounds on reading speed and comprehension and testing the effects of distracters on target detection and recognition. An industrial example might test the effects of variable temperatures on the properties of a material or product. An example of laboratory trials research in vision science might involve the repeated presentation of 19 smiling faces and 1 frowning face with random placement on a computer display with the objective of measuring the effects of distracters on the detection and location of an object in a visual space.

An example of an application of the toolkit in a survey in vision science is an online questionnaire for a sample of individuals who have been fitted with Irlen tinted lenses, which seeks to learn whether the lenses were used, how they were used, and what problems were encountered.

An example of an application of the toolkit in an observational study in vision science is a systematic recording of observations of accident avoidance behaviors and confrontations in a busy corridor at a convention for blind people.

### 3.0. PROTOCOL DESCRIPTION

### 3.1. BASIC PROTOCOL PROPERTIES AND CONSTRUCTION

A protocol in accordance with the present invention is an online “program” or “script” created by researchers or other users using the toolkit to define and guide events in experiments, clinical trials, surveys, and other kinds of studies. These protocols are created online and executed online. New protocols are made by customizing existing protocols built by the developers, contributors, and or created by other toolkit author/designers. Also, new protocols are made by modifying protocols from a researcher's own personal library of protocols. If desired, protocols can be created from scratch with the toolkit's step-by-step assistance, contextual help, and help by topic and key words.

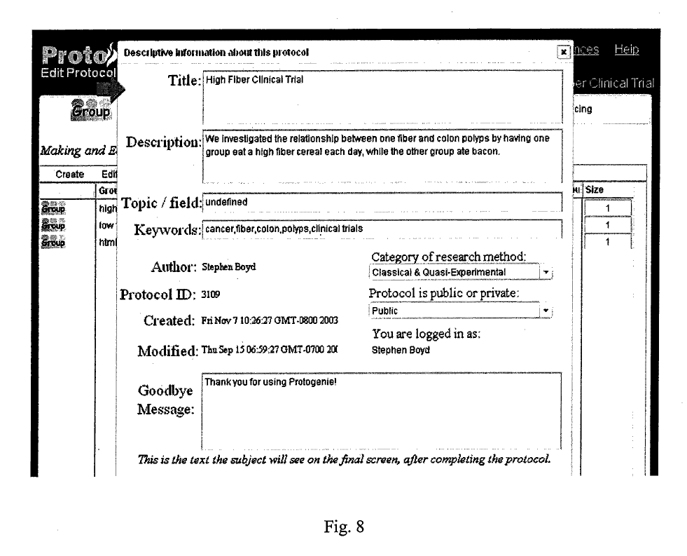

In the context of the present invention, protocol descriptions contain information about each protocol, including the title, a description of the study, the topic and field, keywords that identify the study, author's name, protocol number, date created, date last modified, research method category, and status of the protocol (public or private) or the like. For example, FIG. 8 illustrates a typical description window for a protocol. This information is typically entered when a protocol is created and it is attached to the protocol record in the database to enable effective searches for protocols that fit an author/designer's study.

A toolkit editor (also referred to herein as a “composer/editor”) is a central component of the toolkit. The composer/editor enables researchers to create and modify protocols to guide their studies. Actions include the specification of groups, treatment events, measurement events, control events, and sequencing.

A toolkit database contains the toolkit protocols that have been completed or are in progress and results from executing protocols in the form of data files. Protocols are retrieved through public or personal library lists, by title, ID number, author, or by keyword searches.

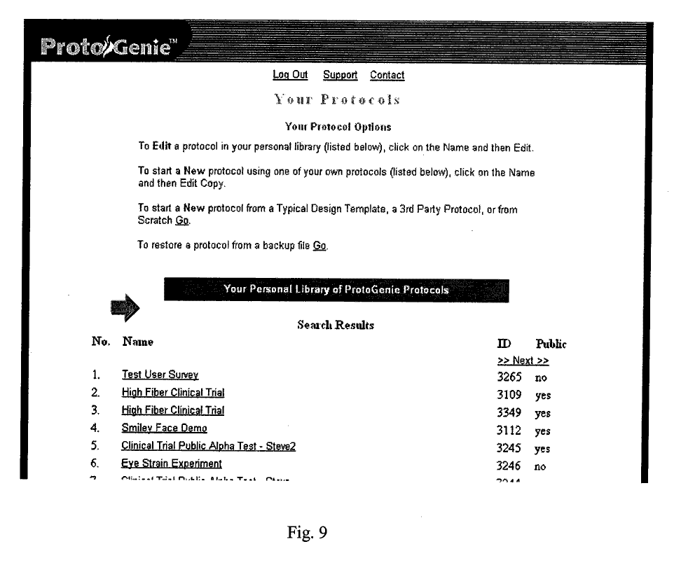

In accordance with one embodiment of the present invention startup protocols are provided. For example, with reference to the exemplary screenshot of FIG. 9, in the presently described embodiment, four alternative sources of protocols from which to choose a startup protocol exist: Blank protocol, Personal protocols, Typical design protocols, and Third Party/general library protocols.

One alternative startup protocol is a blank protocol. In a blank protocol the input fields for defining groups and specifying session events are presented but are completely empty. This choice over existing protocols is mostly a matter of preference and objectives.

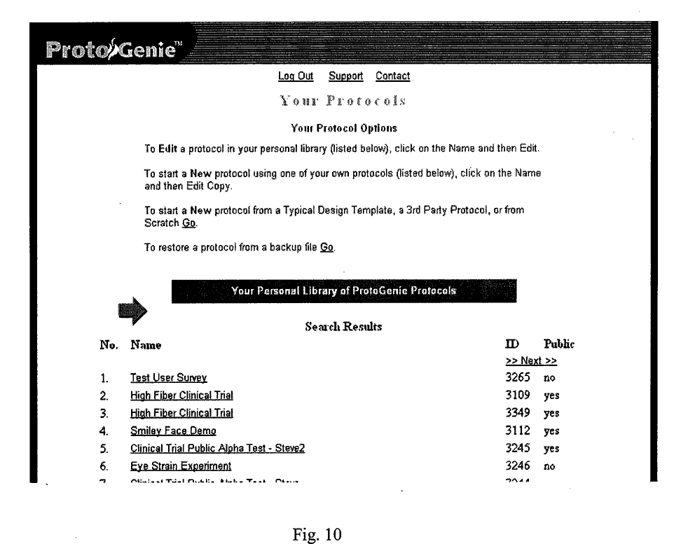

A second startup alternative, illustrated in the exemplary screenshot of FIG. 10, is a protocol from an author/designer's own personal library of the toolkit protocols.

A third startup alternative is a protocol from a library of typical designs for the method selected. For example, a typical design for classical control group experiments is the popular pretest-posttest control group design in which one group receives a treatment with measurements before and after while the other group gets only the pre and posttest measurements. In these protocols, the locations in the specific designs where groups, measurements, and treatments are to be presented are indicated, but they are not specified. For example, where a treatment is to be defined in the protocol the label will simply be “Unspecified Treatment.”

A fourth startup alternative is a protocol from a public library of pre-built and third party protocols. For example, such protocols may be accessed through a keyword search. The general idea is to find a protocol that someone else has created that is close to your study.

Thus, through the use of protocols, the toolkit is a revolutionary research design tool set that reinvents the way research software is created to support experiments, clinical trials, human factor, industrial, surveys and other kinds of research and evaluation. The toolkit slashes the costs of old-fashioned computer software by eliminating highly specialized coding and inflexible one-shot programs. The toolkit's friendly and intuitive interface is grounded in the logic of scientific method and is a web page. All of this enables programmers and non-programmers alike to build powerful, configurable, and recyclable research support applications at radically lower costs.

In its various embodiments, the toolkit and protocols provide a secure worldwide research environment for researchers to share software and information and to reduce the dependence on software engineers and costly fixed applications. The Internet makes this rich research environment possible and the toolkit is designed to grow and evolve with universal access and open source tools.

A central principle is the conservation of software achieved through the recycling of protocols. In other words, the toolkit treats protocols as research capital to be exploited, not wasted. To make protocols available to other toolkit users, an author/designer logs on to the toolkit. For Example, as described further hereinbelow, from the list of personal protocols in the user's personal library, an author/designer clicks on the “Name” associated with the protocol to be made public. Next an author/designer clicks on the Edit link and then on the Description link.

In the Description window there is a drop down menu titled Protocol Public or Private. To make the protocol public, an author/designer clicks on the security option “Public.” By default any new protocol is Private. Alternatively an author/designer may click on the Users link and choose Public. In this regard, “public” does not mean that others can change an author/designer's original protocol or get at an author/designer's data or findings. It simply means that others can make a copy from which to shape their own protocol. An author/designer can provide access to a protocol that is Private on a person-to-person basis by typing the person's email address under “Add a User to Your Protocol” and specifying under that the access options intended for that person.

### 3.2. TRIPARTITE LOGIC OF THE PROTOCOL CONSTRUCTION PROCESS

In preferred embodiments of the present invention, a “tripartite logic” of the protocol construction process defines groups, measurements, treatments, and support, events, and assigns them to the groups in the order that they will be executed with the ability to duplicate individual events and whole sets of events, thereby eliminating the need to create all groups and events from scratch.

In this embodiment of the invention, the toolkit distinguishes between “events” and “names (or labels) of events, the latter of which simply point to an event. Consequently, the same name can be used in more than one place in a group and in more than one group and the actual event will execute when the protocol comes to that name, eliminating the need to create the same event every time an identical event appears in a research design. This is consistent with the re-cycling philosophy of the toolkit, which is aimed at eliminating the practice of using software or parts of software once and throwing it away.

When there are many groups and many events, there are several possible strategies for creating the lists of events in groups. For example, an author/designer may create all of the groups and all of the events in group and then enter the event names in the groups. Or an author/designer may create the first group and create all of the events for that group and then enter the event names in that group. And after creating that first group, an author/designer creates the next group and repeat the previously mentioned procedures procedure. Alternatively, an author/designer may create the first group, create the first event for that group and then enter the event name for that specific event in that group. Only then does an author/designer create the next event and repeat the foregoing. In still another alternative, an author/designer creates and list the names of the Treatment and Control Events before creating and listing the Support Events in the groups.

Instead of creating an event from scratch when it is similar to one that already exists, the toolkit enables an author/designer to duplicate the one that is similar, customize it to fit, and delete the event name that is not correct. Another powerful timesaving feature enables an author/designer to duplicate an entire group.

### 3.3. SUPPORT OPERATION IN THE TOOLKIT

### 3.3.1. SETTING UP AN ACCOUNT

Accounts for the toolkit may be set up and processed using any convention or new means. For example, in a preferred embodiment, a toolkit membership is free and entitles users (author/designers) to use the toolkit Composer/Editor to create and modify their own protocols, to copy and use any toolkit protocols that are assigned public status, and to store results in the toolkit database. A toolkit forum exists to connect author/designers with each other and the toolkit developers, to post questions, to find answers, or simply to show off your protocols.

Setting up an account is a suitably simple process. First, an author/designer opens the toolkit website at a pre-defined website, clicks on the “Sign Up” link at the top of the toolkit home page, and then follows instructions. An author/designer's email address is the login name and the password is created by the author/designer. After submission the author/designer receives an email confirming membership with all attendant privileges.

Toolkits in accordance with the present invention are offered as on-line applications providing log in access independent of equipment and operating systems. It provides a standard and familiar user interface and an open architecture consistent with the philosophy of the toolkit. It provides a user forum and an integrated help system.

Log In is preferably accomplished by conventional email/username and password recognition. For example, an author/designer first opens the toolkit website, clicks on “Log On” at the top of the toolkit home page (or any other page of the Website). This brings up a box containing fields for log on name (email address) and password. Entering this information and clicking on “Log On” opens a page welcoming the author designer to the toolkit.

### 3.3.2. HELP FEATURES

Use of the toolkit is generally straightforward and intuitive. Additionally, numerous means for assisting author/designers with use of the toolkit are prevalent throughout the toolkit's environment.

In accordance with various aspects of the present invention an on line help system is included. The help system is accessed by clicking on the “Support” link in the top menu of any toolkit Web site page. The toolkit's familiar Web-based interface and help system make learning and using the toolkit to create powerful research protocols easy and enjoyable.

The toolkit help system includes the option to view the help file as a Table of Contents with topic descriptions or to search an Index of Key Words. To go to the Help system in the toolkit website, an author/designer clicks on the Support link in the top menu of any page of the toolkit Web site.

To go to the Help system in the toolkit website, an author/designer clicks on the “Support” link in the top menu of the home page. To view the Table of Contents, an author/designer clicks on the label “Contents” to the left of the label “Index” at the top of the panel on the left side of the screen.

### 3.4. THE USE OF TEMPLATES IN THE TOOLKIT

As noted above, in accordance with various embodiments, an important aspect of the present invention is the toolkit Composer/Editor. The toolkit Composer/Editor is an authoring program that enables an author/designer to create new protocols or edit existing protocols via the Internet.

In accordance with an exemplary embodiment, and with reference back to FIG. 9, the first screen after logging on contains Startup Options. Choices on this screen include searching for and opening protocols, creating protocols from scratch, opening a typical design as a template, accessing the tutorials for new users and backing up and restore personal protocols by creating encrypted copies on a author/designer's local hard drive. Clicking a protocols Name and then clicking Edit or Edit Copy puts the author/designer into the Composer/Editor where he or she can create or edit protocols.

### 3.4.1. HOW PROTOCOL ARE CREATED: OVERVIEW

In an exemplary embodiment of a toolkit in accordance with the present invention, there are six basic steps to creating a protocol. First, as set forth above, an author/designer logs on. Next, the author/designer selects “Make New Protocol From Scratch (Blank Protocol)” or “Search Your Protocols Or General Library Of Protocols” for a template. Once a protocol similar to the author/designer's study is found he or she clicks the “Name” link and then the “Edit Copy” link. If the author/designer is the original author then “Edit” will be an available option. After clicking Edit or Edit Copy the next screen is the Composer/Editor. From this toolkit page author/designers then create and name groups, make and edit events or sequence events. Functions from this page also include edit description, save, save as, execute (run), generate URL, setting preferences and accessing the support and help feature.

### 3.4.2. HOW EXISTING PROTOCOLS ARE USED FOR TEMPLATES

As noted above, the first screen after logging on contains the toolkit Startup Options. See FIG. 9. As briefly mentioned above, there are four sources of the toolkit protocols from which to choose a protocol to use as a template for making a new protocol.

To use a protocol in an author/designer's personal library as a template for a new protocol, an author/designer clicks on the title of that protocol.

If author/designers decide to use a blank startup protocol or a protocol from the Typical Design Library or a protocol from the General Library of Protocols, they click on the desired option. In accordance with various aspects of the toolkit, details on research methods may be provided, for example, by clicking on the link labeled “See Methods Definitions” to the right of the pulldown list of methods.

To start a new protocol from scratch or to search for protocols, an author/designer clicks on the closest method from the research methods pull down menu. As noted above, the presently described exemplary, non-limiting embodiment of the toolkit supports categories or methods as detailed above (though more or less are likewise contemplated as within the scope of the present invention). Examples include Archival Research, Case Study Research, Classical & Quasi-Experiments, Clinical Trials Research, Cohort Analysis, Combined Methods Research, Laboratory Trials Research, Longitudinal Analysis and Observational Research, and Survey Research.

### 3.4.3. SEARCHING THE GENERAL LIBRARY OF PROTOCOLS

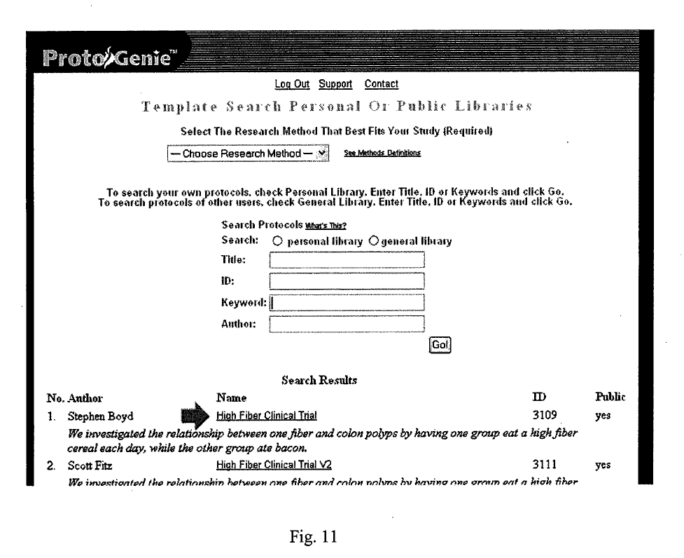

The General Library of Protocols is an archive of protocols that have been created using the toolkit Composer/Editor. This archive is searchable by ID number, title, research method, key words and author. Each protocol is given a status of private or public by the author. In the present embodiment, the default status is “Private” unless the author otherwise resets the status to “Public.” For example, FIG. 11 illustrates an exemplary search page, including an option to search the General Library.

For Public protocols created by other author/designers, the only Actions available are Run and Edit Copy. If Edit Copy is used and that copy is saved, all Actions available to an original author/designer (Run—Edit—Edit Copy—Users—Results—Cases—Back Up—Delete) will be available when the saved copy is accessed.

To conduct a search of the General Library of Protocols, an author/designer Logs on and selects the third option on the Startup Options Page, selects the research method closest to his or her study, and then queries the general library by keyword or ID number.

### 4.0. DESCRIPTION OF THE AUTHORING FUNCTION OF INVENTION: THE COMPOSER/EDITOR

### 4.1. STARTING A PROTOCOL

### 4.1.1. HOW AN AUTHOR/DESIGNER ENTERS THE COMPOSER/EDITOR

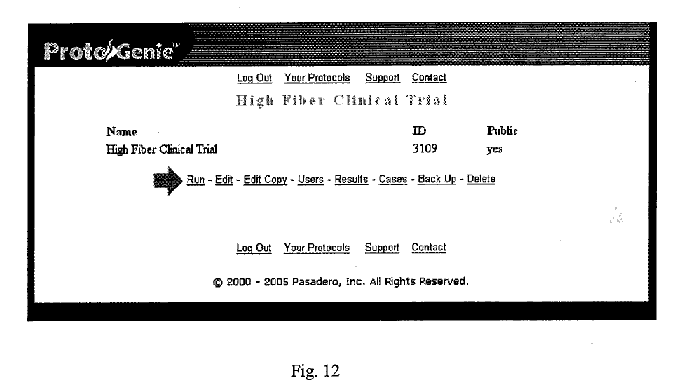

With reference to FIG. 12, to use a protocol from his or her personal library as a template for a new protocol, an author/designer clicks on EDIT COPY in the User Action Links Page.

This will bring up the toolkit Composer/Editor page containing a copy of the desired protocol ready for changes required by the author/designer's new protocol. Generally, it is not necessary for author/designers to search their own protocols. However, if they have created many protocols it is possible that they will have a long list of protocols in their personal library. In this case, author/designers can use the toolkit search features to find protocols that are close to their current research interest.

The third option on the Startup Page links to the Search Page. To search all public libraries, an author/designer selects “All Methods Search Only” in the pull down menu. The author/designer then moves down to “Search Protocols” and clicks the “Personal Library” radio button. Then, the author/designer types in the approximate title or keywords that may have been entered when the protocol was originally created or later modified. Alternatively, if the protocol ID number is known, the author/designer can search by typing in that number.

Another option on the Startup Page is to use the Typical Designs Library. This library is an archive of partially completed protocols organized by research method. After author/designers select the research area most appropriate to their studies, their list of protocols will contain the protocol designs most associated with their selected research area. For example, a typical design for classical control group experiments is the popular pretest-posttest control group design in which one group receives a treatment with measurements before and after the treatment while the other group gets only the pre and posttest measurements.

In the presently described, non-limiting embodiment, the full list of typical designs for classical control group designs consists of Pretest-Posttest Control Group Design, Solomon Four-Group Design, Posttest-Only Control Group Design, the Time Series Experiment Equivalent Time-Samples Design, Equivalent Materials Design, Nonequivalent Control Group Design, Counterbalanced (Crossover) Designs, Separate-Sample Pretest-Posttest Design, Separate-Sample Pretest-Posttest Control Group Design, Multiple Time-Series Design, and Single Organism Design.

In typical designs protocols, the locations in the specific designs where groups, measurements, and treatments are to be presented contain place holders labeled “unspecified (event)”. For example, where a treatment is to be defined in the protocol the label will simply be “Unspecified Treatment.” The same applies to measurements, control events, and groups.

Since typical design protocols are organized by research method, then the only search criterion is research method and the number of protocols under research methods is relatively small. Consequently, author/designers need only to designate the research method that most applies to their studies.

As noted above, in the present embodiment, there are six research methods supported, namely, Classical & Quasi Experiments, Clinical Trials, Laboratory Trials, Survey Research, Observational Research, and Combined Methods Research.

The fourth source of startup protocols is a Blank protocol. In Blank startup protocols, the input fields for defining groups and specifying session events are presented but are completely empty. Choice of starting with existing protocols or a blank protocol is mostly a matter of preference and objectives.

### 4.1.2. UNSPECIFIED GROUPS & EVENTS

Unspecified groups and events are generally used in startup protocols from the Typical Designs Library where the aim is to indicate where groups and events occur by design but are not fleshed out. For example, a typical experimental design is the Solomon Four-Group Design.

An unspecified treatment event is used to hold a place for a single treatment, two unspecified measurement events are use to hold places for two measurements, and there are four undefined groups. Also, unspecified treatment and measurements are placed on a time line for each group as specified by the Solomon Four-Group design. An author/designer's task is to specify each unspecified group and event. Besides use in typical design startup protocols, it is conceivable that some author/designers would insert unspecified groups or events in a protocol to remind themselves that they want to add a group or event that they have not yet conceptualized or defined.

### 4.1.3. HOW AUTHOR/DESIGNERS START A PROTOCOL USING A BLANK PROTOCOL

Rather than using a startup protocol from an author/designer's personal library, typical design library, or the toolkit general library, author/designers have the option to start with a blank protocol. With this option, they will see the same windows had they selected a startup protocol from one of the above sources, except the fields will be empty.

This option is generally preferred by more experienced users when they are starting a completely new and different study. To use the Blank Startup Protocol option, an author/designer chooses a research method under the Research Method drop down menu and than clicks the Blank Protocol button.

### 4.1.4. HOW AUTHOR/DESIGNERS USE THE RESULTS OF LIBRARY SEARCHES

For each item in a protocol search result, author/designers are given the title of the protocol and a short description of what the protocol does. For example the Name of an item might be “Effects of Computer Animation on Jury Decisions” and the description might read, “This study examines the effects of presenting computer animations in the courtroom for the plaintiff and for the defendant on the decisions of jurors regarding guilt and innocence.” If a particular protocol looks promising, an author/designer clicks the protocol's Name and then clicks “Run.” This executes that protocol just as if an author/designer were conducting a session using that protocol. In effect, this is a preview of what the protocol does. When the run is completed, the author/designer will see a results screen. This process can be repeated until the author/designer has decided on a startup protocol to use as a template for creating his or her protocol. After a start up protocol has been decided on, the author/designer selects “Edit Copy” from the action menu and this puts the author/designer in the toolkit Composer/Editor.

### 4.1.5. USER ACTION OPTIONS

In accordance with another aspect of the present invention, User Actions are presented in a list for all protocols. Protocols in an author/designer's Personal Library of Protocols are listed on the Your Protocols page. Protocols are also listed whenever a search of the General Library of Protocols is made.

The specific items in the lists of user actions will vary according to user permissions. In the presently described embodiment of the toolkit, in the case of a protocol in an author/designer's personal library, with reference to FIG. 12, there are six actions listed: 1 Run—Execute selected protocol in the list (must be in personal library or designated public), 2 Edit—Edit selected protocol in the list (must be in personal library), 3 Edit Copy—Make a copy of selected protocol in the list (must be in personal library or have a public security status), 4 Users—This is a list of author/designers who have been added to the Designated User List attached to selected protocol, 5 Results—This option enables an author/designer to look at the results of previous runs of selected protocol, and 6 Delete—This enables the author/designer to delete the selected protocol.

### 4.1.6. HOW PROTOCOLS ARE OPENED

To open a protocol in an author/designer's personal library of protocols, an author/designer logs on and double-clicks on the desired protocol's name. This brings up the toolkit composer/editor containing the selected protocol. This is the page where most protocol composing and editing takes place. If the author/designer has used the search feature of the toolkit on the Start Up Search page to find a protocol, a list of protocols matching the author/designer's research criteria will appear at the bottom of the page. To open a public protocol, the author/designer simply double-clicks on its Name. This will bring up the toolkit composer/editor containing the selected protocol.

### 4.2. OPERATIONS IN THE COMPOSER

### 4.2.1. COMPOSING PROTOCOLS

After logging in and selecting a startup protocol from the Typical Designs Library, General Library, or Personal Library to use as a template, author/designers are ready to begin composing a new protocol from a copy of the old. As mentioned above, the first screen after logging on contains six Startup Options. Making choices on this screen puts an author/designers into the Composer/Editor where they create or edit a protocol. The toolkit Composer/Editor is the authoring program that suitably enables author/designers to create new protocols or to edit their own protocols on the Web.

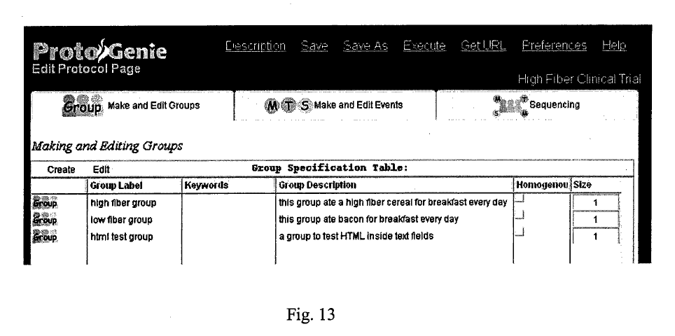

After selecting Edit or Edit Copy in the user action menu, an author/designer is taken to the page called the “Edit Protocol Page” ready to begin composing or editing an existing protocol (FIG. 13) The Edit Protocol Page contains three tabs beginning on the left with the tab called Make & Edit Groups. The second tab is Make & Edit Events and the third tab is Sequencing. Groups and events are made under the first two tabs and their names are listed and sequenced under the third tab. Upon arrival to the edit protocol page, the author/designer will always be looking under the Make & Edit Groups tab.

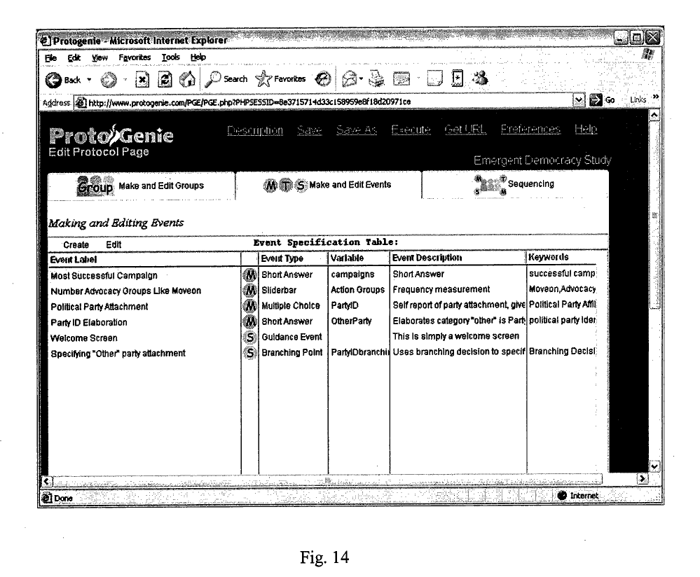

With reference to the exemplary screenshot of FIG. 13, in the Make & Edit Groups Window, there will always be at least one group listed. Even when starting with a blank protocol, there will be an “Unspecified Startup Group” in this window. Additionally, with reference to FIG. 14, in the Make & Edit Events Window, there also will be at least one event listed in the Event Specification Table, even when starting with a blank protocol, in which case, that event will be called “Unspecified Startup Event.

Under the Sequencing tab, on the right side of the screen is a window called “Execution List.” There will always be at least one group and one event displayed in this window.

To the left of the Execution List is a window called “Event Names.” This window will contain the names of all of the events and author/designer has made for this protocol. This list of names is entered into the treatment group in the Execution List Window from the Event Names Window. This is done by selecting the destination, which is the treatment group in the Execution List Window, selecting an event in the Event Names Area, and clicking on the arrow labeled Enter Event Name.

### 4.2.2. PROTOCOL DESCRIPTION WINDOW

The first time that an author/designer enters the Edit Protocol Page a Protocol Description window will pop up automatically. For example, FIG. 8 illustrates a typical description window for a Protocol. The reason for this is the importance of describing protocols for use by other potential author/designers. The description in this window can be modified at any time by clicking on the Description link in the top menu of the composer/editor page.

The Protocol Description Window contains fields for the title, description of the study, topic/field, keywords, author, protocol ID, when created, last modified, category of research, public access status, and current user.

Note that in this embodiment, there is no input field for “Author” because the login name of the principle author/designer of the protocol will automatically appear in this field. Searching for a suitable protocol for use as a template by author's name is one of the available search options. Further, there is no input field associated with “Protocol ID” because this number will be automatically assigned at the point the protocol is saved to the database. Until that time, a note will say that “No ID has been assigned yet.” The dates “Created” and “Modified” are filled automatically by the toolkit.

### 4.2.3. RESEARCH CATEGORIES

In the presently described embodiment of the present invention, there are two pulldown menus in the lower right-hand quadrant of the Description Panel that are particularly important to other potential author/designers. The first is labeled “Category of Research Method.”

A research category will be showing in the window when a protocol has been selected. If for some reason it is not the method an author/designers wishes to use, then they can change it here. However, it must be kept in mind that the format of protocols varies by research method.

Therefore, it is advisable to return to the Personal Library or the Public Library and re-select a research method there.

### 4.2.4. PROTOCOL PERMISSION STATUS: PUBLIC AND PRIVATE

This pulldown menu has two options, “Public” and “Private” and is discussed in several contexts and applications herein. The default setting is “Private,” meaning that no one can access the protocol without the express special permission of the author. If author/designers know that they would like to permit all the toolkit members to copy and use the current protocol as a template for their own studies, then “Public” is selected. This permission status can be changed at later times if desired.

In accordance with various aspects of the present invention, if a protocol is designated “Private” and an author/designer wishes to give special access to specific toolkit members or non-members by name and email address, this can be done on the Personal Library page by clicking on the protocol name, then the Action pulldown menu, and then click on “Users.”

To add a user, an author/designer clicks on “Add a User to Your Protocol” and then types in the person's email address. Under the email address, the author/designer then specifies the access options to be given that person. For example, selected options may include: Run, Edit Copy, Edit, Users, Results, and Delete.

Generally speaking, author/designers would not check the Edit permission unless the situation involved a collaboration or team effort because this option allows the added user to make changes in the original copy. Run means execute and only this if no other permissions are checked. Edit Copy means that the added person can make a copy and change it at will. The option “Users” allows persons with that permission to look at and modify the designated user list. Results give the authorized person the ability to view and add to the designated users list.

### 4.2.5. HOW NEW PROTOCOLS ARE SAVED

Once panels have been completed or changes have been made, author/designers will generally want to save their new protocol to the toolkit database. This is done by clicking on the “Save” option in the top menu.

Author/designers are encourages to give their new protocols a title and save them immediately after choosing and opening a startup protocol (either blank or from the toolkit library) and saving them thereafter at every major step. Also, after every major work session, it is considered a good practice to make and save a copy as a backup protocol in case radical changes were made and the author/designers decide that they were not what they wanted.

Protocols are saved by clicking on the SAVE or SAVE AS link located at the top menu bar of every screen in the Composer/Editor. If SAVE AS is selected, the name of the protocol can be changed. This is another way to make a back up protocol.

The saving of protocols should be carefully distinguished from the saving of the results of the execution of protocols.

### 4.3. HOW GROUPS AND EVENTS ARE CREATED IN THE TOOLKIT

### 4.3.1. HOW EXPERIMENTAL GROUPS ARE CREATED WITH THE TOOLKIT

The word “Groups” is used mostly in experimental research. However, the word “Panels” is frequently used in survey research and other research methods. In accordance with various aspects of the present invention, there are two kinds of groups in experiments, Treatment Groups and Control Groups. With toolkits in accordance with the present invention, Experimental Groups of subjects may be defined for controls and comparisons in experiments. Subjects may be assigned to different groups based on subject attributes or they may be randomly assigned to groups that will receive different treatments. A special category of treatments is “no-treatment.” Groups given no-treatments are generally called “control groups.”

Consequently, the major categories of experimental groups are Treatment Groups and Control Groups. In some fields, “treatments” are called “interventions” and in others, they are called “Stimuli.” Consequently, groups in which an intervention or a stimulus is presented are called “intervention groups” and “stimulus groups,” respectively.

Thus, the use of Control Groups in experimental research helps distinguish between effects on subjects that are due to treatments and effects that are due to history and other threats to validity. In this regard, subjects in the typical control group are not presented any treatment.

Groups may also be used to determine whether a treatment has greater effects on one population than another. For example, a teaching method might be more effective with males than it is with females. In this case, there might be three groups: one consisting of male subjects, one consisting of female subjects, and one consisting of males and females who do not receive the treatment. These groups are generally called “Control Groups.”

### 4.3.2. HOW GROUPS ARE CREATED IN THE COMPOSER/EDITOR

The creation and editing of groups and events is done in the Composer/Editor of the toolkit in the Edit Protocol Page. For example, referring to the screenshot of FIG. 13, a page in the Composer/Editor contains three tabs beginning on the left with the tab called Make & Edit Groups. The second tab is Make & Edit Events and the third tab is Sequencing. Groups are made under the first tab. Upon arrival to the edit protocol page, an author/designer will always be looking under the Make & Edit Groups tab. In the Make & Edit Groups Window, there will always be at least one group listed, even when starting with a blank protocol.

To add a group an author/designer clicks on the Make and Edit Groups tab of the Edit Protocol Page. Then the author designer clicks on Create (New Group). This inserts a new group called “Unspecified Group” in the list of groups in the Group Specification Table, where a new name can be assigned to the group. Sometimes the properties of groups differ only slightly and so it can be a great time-saver to add a copy of an existing group and modify it to fit. To make a copy of a group, an author/designer clicks on the group, then on Edit, and then on Duplicate.

To remove a group from the Group Specification Table, an author/designer clicks on the group to be removed, clicks on Edit, and then on Delete.

Generally, sessions for groups begin at the same time, so that the order of the groups in the Group Specification Table does not matter. However, design calls for groups to start at different dates and/or times, they can be ordered in the Group Specification Table. The order of groups in the group list box is the order in which they will be treated in the experiment.

Groups of subjects are often defined for controls and comparisons in experiments.

Subjects may be assigned to different groups based on subject attributes or they may be randomly assigned to groups that will receive different treatments. A special category of treatments is “no-treatment.” Groups given no-treatments are generally called “control groups.” Control groups are created using the same operations that are used to create “treatment” groups, as in the above.

### 4.3.3. HOW EVENTS ARE CREATED IN THE COMPOSER/EDITOR

Various embodiments of the present invention utilize three TYPES of events to be added to a protocol—measurement events, intervention (treatment) events, and support (procedural) events. The creation and editing of events is done in the Composer Editor of the toolkit in the Edit Protocol Page. This page contains three tabs beginning on the left with the tab called Make and Edit Groups. The second tab is Make and Edit Events and the third tab is Sequencing. Events are created under the second tab, namely Make and Edit Events.

To create and event, an author/designer clicks on the Make and Edit Events tab (e.g., as illustrated in FIG. 14), then on Create, and then on the type of event to be created. This presents a dropdown list of operations options for the selected type of event. For example, if adding a measurement event, the author/designer will get a list of operations beginning with the operation or instrument option called “Multiple Choice.”

When an operation (such as “Multiple Choice) is selected, a window comes up allowing an author/designer to specify that operation. For example, the multiple-choice option lets the author/designer type in a question, select the number of choices, and define the choices.

To remove an event, an author/designer clicks the event once to select (highlight) it, clicks on Edit, and then on Delete.

In surveys a measurement event is an action taken to determine attitudes, beliefs, knowledge, skills, memory, dispositions, and feelings. In experiments, a measurement event is an action taken to determine whether something happened or changed in an experiment in response to a treatment (intervention or stimulus). Measurements generally involve things author/designers want to learn about in their studies and are usually referred to as “dependent variables” or “response variables.” This is because they depend on or are responses to other factors that are to be explored, evaluated, or used to produce a change.

Examples of dependent variables are “jury verdicts,” “reading performance,” and “reaction time.” Variables must be “operationalized,” meaning that author/designers must specify exactly how they are measured. For example, a question might be asked or a blood pressure might be taken. These actions are measurement events.

Measurement Types are sometimes referred to as measurement instruments because they measure knowledge, attitudes, and beliefs in a survey, observations on observational research, or the effects of a treatment in an experiment or clinical trial. In the presently described embodiment of the toolkit, there are 12 types of measurements available in the toolkit (though those skilled in the art will appreciate that other types may likewise fall within the scope of the present invention). These types are Multiple Choice, Slider Bar, Short Answer, Rank & Order, Matching, Fill-in-the-blanks, True-False, Checkbox, Drop-down Menu, List Box, Rating Scale, and Unspecified Measurement.

### 4.3.4. HOW MEASUREMENT EVENT ARE CREATED IN THE COMPOSER/EDITOR

As contemplated herein, a Measurement Event is one of three kinds of study events: Measurement Events, Treatment Events, and Support Events. A measurement event is an action taken to determine whether something happened or changed in an experiment in response to a treatment (intervention or stimulus).

To add a new Measurement Event, an author/designer first clicks on the Make and Edit Events tab in the Edit Protocol Window. The author/designer then clicks the Create button above the Events Specification Table, chooses the event category labeled “Measurement,” and then chooses the measurement type from the drop down list. This presents a new event (row) in the “Event Specification Table.” In the first column for this row, there is an “M” in a circle indicating that this event is a Measurement. To its right is the event type and to its right is a field to describe the event.

Selecting a measurement event in the Event Specification Table brings up a construction area window where the author/designer prepares and configures the measurement instrument.

### 4.3.5 HOW TREATMENT EVENTS ARE CREATED IN THE COMPOSER/EDITOR

As contemplated in various embodiments of the present invention, a treatment event is an action taken to manipulate something in an experiment to study its effects on a dependent variable. For example, a researcher might be interested in studying the effects of drinking coffee on reading performance. Treatment variables are called “treatments,” “interventions,” “change variables,” and “stimuli,” depending on the nature and setting of the study.

The statistical term for these variables is generally “Independent variables,” although this may be deceiving since variables are seldom independent of other influences. Treatment variables can be categorical in measurement as in “gender” or continuous, as in “letter contrast.” In statistical analysis, categories are generally called “levels” and these are often treated as separate treatments.

For example, a researcher might investigate and compare the effects of blue, green, gray, and no filters on reading speed. The planned manipulation of an independent variable is a treatment event.

Treatment Events are also known as “Intervention Events” and “Stimulus Events,” depending on research method and field. As used herein, a Treatment Event is one of three kinds of experimental events: Measurement Events, Treatment Events, and Support Events.

A treatment event is an action taken to manipulate something in an experiment to study its effects on a dependent variable. For example, an author/designer might be interested in studying the effects of drinking coffee on reading performance.

In the presently described embodiment of the toolkit, there are 8 types of treatment available in the toolkit (though those skilled in the art will appreciate that other types may likewise fall within the scope of the present invention). These types are 1) Administered by Experimenter, 2) Administered by Machine, 3) Administered by Other, 4) Administered by Subjects, 5) Administered on Computers, 6) Administered by Video, 7) External Stimulus, and 8) Unspecified Treatment.

To add a new Treatment Event, an author/designer first clicks on the Make and Edit Events tab in the Edit Protocol Window. The author/designer then clicks the Create button above the Events Specification Table, chooses the event category labeled “Treatment,” and then chooses the treatment type from the drop down list. This presents a new event (row) in the “Event Specification Table.” In the first column for this row, there is a “T” in a circle indicating that this event is a Treatment. To its right is the event type and to its right is a field to describe the event.

Selecting a treatment event in the Event Specification Table brings up a construction area window where the author/designer prepares and configures the treatment.

### 4.3.6 HOW SUPPORT EVENTS ARE CREATED IN THE COMPOSER/EDITOR

In the context of the present invention, a Support Event is one of three kinds of experimental events: Measurement Events, Treatment Events, and Support Events. The “tactical” or “operational” part of research protocols (by which is meant treatments and measurements) is vital in a protocol, but much of what has to be done in the conduct of a study involves support and management—and these tasks have to be carefully spelled out too. Unlike treatment or measurement events in a protocol, “Support Events” are events strategically placed to make ready, facilitate, guide, or otherwise manage a study. Simple example of Support events include screens that instruct subjects or respondents what to do at specific places in the protocol or simply provide some information at specific places in the execution of the protocol. Support Events also are used to organize multiple treatments or measurements into arrays.

There are eight major types of “Support Events.” They are 1) Guidance Events, 2) Branching Point Events, 3) Calendarize Vents, 4) Event Iterations, 5) Event Arrays, 6) Study Context, 7) Unspecified Support Events, and 8) Goodbye Events.

To add a new Support Event, an author/designer first clicks on the Make and Edit Events tab (FIG. 14) in the Edit Protocol Window. The author/designer then clicks the Create button above the Events Specification Table, chooses the event category labeled “Support,” and then chooses the Support type from the drop down list. This presents a new event (row) in the “Event Specification Table.” In the first column for this row, there is an “S” in a circle indicating that this event is a Support event. To its right is the event type and to its right is a field to describe the event.

Selecting a Support event in the Event Specification Table brings up a construction area window where the author/designer defines the Support event. For example, if the author/designer selects, “Guidance Event,” a window will appear in which the author/designer types what will appear to the end-user when that event is encountered in an execution.

### 4.3.7. HOW NULL EVENTS ARE CREATED IN THE COMPOSER/EDITOR

As used herein, a null event acts as a “time-slot holder. Unlike a treatment, measurement, or other types of support event, nothing happens when the program is executed and a Null Event is encountered. The purpose of inserting null events is to fill the time intervals in which other groups are presenting measurements or treatments—thereby aligning measurements and treatments across groups and assuring that measurements and treatments are presented at the appropriate time in each group.

To add a Null Event, an author/designer first clicks on the Make and Edit Events tab in the Edit Protocol Window. The author/designer then clicks the Create button above the Events Specification Table, chooses the event category labeled “Measurement,” and then chooses Null Event. This presents a new event (row) in the “Event Specification Table.” In the first column for this row, there is an “M” in a circle indicating that this event is a null Measurement event. To its right is the event type and to its right is a field to describe the event.

Selecting this event in the Event Specification Table brings up a construction area window where the author/designer defines the Null event.

### 4.4. HOW EVENTS ARE SEQUENCED IN THE COMPOSER/EDITOR

As described above, composing toolkit protocols involves two major sets of operations. The first is to create groups and events. The second is to sequence them.

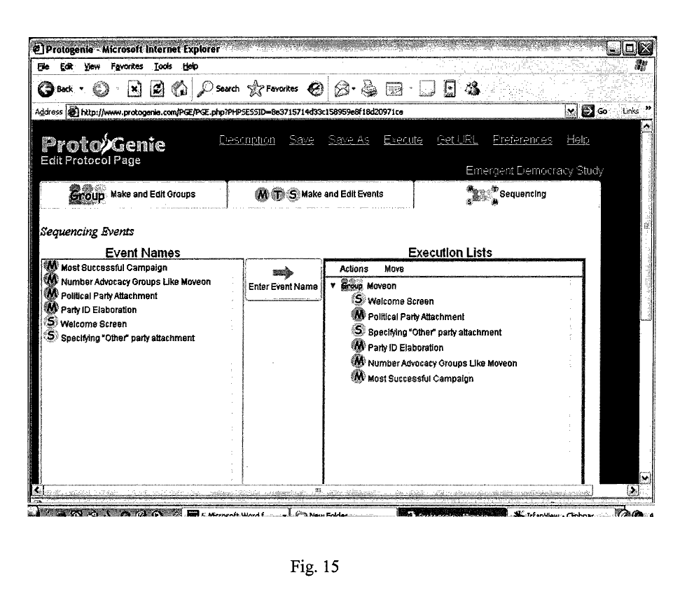

With reference to FIG. 15, to sequence events, the author/editor clicks on the Sequencing tab of the Edit Events Window in the toolkit's Composer/Editor. Then the author/editor 1) clicks on the group in which events will be sequenced, 2) clicks on the name of the first event in the Event Names Window that should be presented in that group, and 3) clicks on the arrow called “Enter Event Name” that points from the Event Names Window to the Execution List. This process is repeated for each event name in the Execution List. When the protocol is executed, events will be executed in the order in which the event names appear in the Execution List.

To change the order of presentation, the author/editor selects the event to be moved, clicks on the Move menu above the Event Specification Table, and uses the UP and DOWN options to move the event where it should be in the proper order of execution.

### 4.4.1 HOW EVENTS ARE CYCLED IN THE COMPOSER EDITOR

The normal sequencing of events in the Execution List assumes that each event will be presented once. However, in many designs, the same treatments and events are executed more than once and often many times, as in human or materials performance testing. For example, imagine a car door slamming 10000 times and taking a materials fatigue test after each slam. We would require an impossibly long list of events in the Execution List. Other examples include Clinical Trials, where for two years an experimental drug is taken every two days followed by a blood pressure test.

This toolkit provides the ability to cycle any event in the Execution List the desired number of times. This is much like using a “For/Nest” or “Do Loop” with incrementing in basic programming to repeat an operation a given number of times. To do this in the composer/editor, an author/designer clicks on the Make and Edit Events tab, then on Create at the top of the Events Specification Table, then on Support, and then on Event Iterations. The author/designer then clicks on the button labeled “Cycle Events” located between the Assembly and Event Names areas and in the box labeled “Number of cycles, he sets the number to the desired number of repetitions.

Other situations require more options. For example, consider a typical times series study in which there is a sequence of the same measurement, a treatment, and another sequence of the same measurement. This situation is different from the clinical trial situation because the two events in the Execution List are cycled individually and the measurement event cycle is presented twice.

These and more complicated cycling requirements as in “cross over designs and equivalent materials designs are provided for under the Event Iterations support option. Temporary “groupings” of events for special runs are provided for by this feature.

### 4.5. HOW PROTOCOLS ARE EXECUTED

A protocol can be run (executed) at anytime while in the composer/editor by clicking on the Execute button in the top menu bar. One can also execute a protocol from the User Actions Menu by selecting “Run.”

To execute a protocol, an author/designer clicks on Execute. An execute window will come up. This window contains a yellow panel. To the right of a red arrow, there are two dropdown boxes. The top one is labeled “Choose group.” The author/designer selects the group to be run and immediately below that makes a selection under “Choose Subject.” The subject categories are “Use (Subjects Name) as a subject,” “Have the User Log in to the toolkit,” and Anonymous Subject.”

After making these selections, an author/designer clicks on the large green right arrow with the word “Execute” at the tail of the arrow.

### 4.5.1. HOW PROTOCOLS ARE IMPLEMENTED

Because in preferred embodiments of the present invention, the toolkit protocols are built on the Web and executed on the Web, new ways to implement research are available such as tapping into vast pools of subjects and respondents to participate in surveys and experiments without having to be present or in direct personal contact.

As contemplated in the presently described embodiment, there are two major modes of protocol implementation: Supervised and Self-Administered. The mode that a study calls for will determine what specific access permissions will be needed to conduct the study.

Supervised implementation applies to most conventional research, where the principle investigator, project manager or a project staff member is present to take the survey, administer the treatment and take measurements, or whatever is required to implement the research. This research may be implemented in a single local setting or be implemented in multiple-locations. In this situation, the permission to run the program is provided by the principle investigator in a Designated User List that is attached to the protocol.

Additionally, supervised implementation may be local or in many locations. In Supervised Local Implementations, protocols are executed in or from a single local laboratory or field setting. The authors of the protocols automatically have the necessary permissions to execute the program (and if necessary to modify it). If assistants or other professionals will supervise the implementation, then the principle investigator must either be present to login and open the appropriate protocol or provide run-only access to the implementers in the Designated User List that is attached to the protocol.

In Supervised Multiple-Location Implementation studies may be implemented simultaneously in a number of geographic areas. For example, a survey of entertainment preferences might be conducted in a number of major cities across the country. In these cases, project managers are often assigned to each city. These project managers require the permissions necessary to meet their responsibilities in the project. The principle investigator does this by adding their names to the designated user list and specifying what level of access they have. In larger projects, project managers in other cities might need to enlist a number of general staff people to implement the research and needs the authority to give them run-only access to the protocol. The principle investigator can give this authority to project managers by giving them the title of Project Manager (PM) in the designated user list.

Self-administered implementation applies to research made possible by the Internet, including on-line surveys and even more recently on-line experiments. Protocol access for unsupervised implementation, as in on-line surveys, is provided for by Direct Run-Time URL that takes a remote subject or respondent directly to the execution of the protocol.

Testing and Demonstration Modes the testing of the toolkit protocols is done in several ways. For example, it may be done by persons who are given permissions enabling them to make changes. In other cases, testers may be given only the permission status to run a protocol.

In certain situations, the primary author may want to enable another researcher to execute a protocol in order to demonstrate some feature or to get expert feedback on the suitability of the process for certain population groups. In those situations, an author/designer can “make” a special URL that can be run only in execution mode, which the author/designer can send to the intended user.

Self-administered on-line surveys are essentially questionnaires composed using the toolkit in the usual way and then asking for volunteers (usually on-line) from a target population to complete the questionnaire at their own computer stations and submit it on-line to the toolkit database.

Care must be taken in selecting and reaching online population because there is no direct supervision. Clear and complete instructions are very important.

Direct Access URLs are Internet links that remotely located respondents and subject open on their own systems. An author/designer creates these by bringing up the protocol involved in the Composer/Editor and clicking on the menu button called “Generate URL.”

### 4.6. PROTOCOL SECURITY AND SHARING IN THE TOOLKIT

As noted above, in accordance with various embodiments of the present invention, protocols are designated Public or Private by the Principle Author. Private means that no one but the principle author and people on their designated user lists (see below) can access the protocol. Every new protocol that is created from scratch has the default access status of “Private.” In other words, if the “Blank” startup option was used to create the protocol, then the access status is “Private.” However, if a new protocol is created by modifying a copy of a “Public” protocol, then the access status for that protocol will remain “Public.” If new authors want these protocols to be “Private,” then they must manually change them to “Private.”

If the authors of protocols that have been designated “Private” make copies, then the status of those protocols will remain “Private.” “Public” means that the protocol will appear in protocol searches by other the toolkit users and can be copied and it means that copies can be opened in the Composer/Editor, run, and edited.

When copies are made of public protocols to use as templates, they will have new titles and security status will be tied by log in to the new Principle Author. However, even when the security status is “Public,” originals cannot be opened or modified in any way. This means that only the principle author or his designated users can view the original protocol and any results data associated with that protocol.

Only protocols designated “Public” will appear in the results of keyword searches by other the toolkit users. Individuals must have an account with the toolkit in order to log in and use the toolkit. Only the principle author can change the security status of a protocol from “Private” to “Public.”

There may be times when principle authors need to provide special access to their protocols to develop, test, and implement them. Exceptions include Project Managers and Project Staff (testers and implementers). Such people are given access when they are added to the principle author's designated list of users. When these additions are made, the level of access for each is clearly specified.

### 4.6.1 SHARING TOOLKIT PROTOCOLS IN A COMMUNITY OF RESEARCHERS

In preferred embodiments, the toolkit provides a worldwide network or “secure research environment” of researchers brought together by the toolkit online user forum to share software and information and to reduce dependence on software engineers and costly fixed applications. The Internet makes this rich research environment possible. This environment is designed to grow and evolve with universal access and open source tools.

As mentioned above, a central principle is the conservation of software effort through the recycling of protocols.

### 4.6.2. TOOLKIT USERS FORUM

In accordance with various embodiments of the present invention, user forums may be provided to facilitate questions, comments and the discussion/exchange of protocols. Any conventional forum software may be used in the context of the present invention.

To share protocols with other toolkit users, an author/designer clicks on the protocol to share in his Personal Library, then on “Users” in the User Actions Menu, and then on “Public.”

### 4.6.3 REMOTE ACCESS FOR DEMONSTRATION AND ONLINE APPLICATIONS

In certain situations, an author/designer may want to enable another researcher to execute a protocol to demonstrate some feature or to get expert feedback on the suitability of the process for certain population groups. In these situations, the author/designer can “make” a special URL that can be run only in execution mode, which can be sent to intended users. To make a special URL for execution mode, the author/designer logs into the toolkit, clicks on the protocol in his or her Personal Library of Protocols intended for access in demonstration mode, and clicks on the words “Get URL” in the top menu. Under the pulldown menu labeled “Group,” he selects the experimental group to which the demonstration run will apply. Under the pulldown menu labeled “Log in,” the author/designer selects the option “Have the Subject Login to Existing the toolkit.” Next, he clicks on “Get URL” and a long URL beginning with http will appear in the window below the “Get URL” button. This URL can be copied and pasted into a message to send to the intended viewer. Upon receipt of the URL, the intended viewer will copy and paste it into the “Open” field of his/her browser and press “Go.” This will bring up the first page of the protocol run.

### 4.6.4. SPECIAL ACCESS PERMISSIONS

In the context of the presently described embodiment, there are three special access permission situations: Person-to-Person, Remote Access for Demonstrations, and Remote Access for Online Applications. How an author/designer provides Person-to-Person and Remote Access for Demonstrations is covered in toolkit documentation. Remote Access for Online Application involves experiments designed for volunteers from a target population to execute the protocol at their own computer stations and respond on-line. Care must be taken in selecting, and reaching, and screening these populations. Since there is no direct supervision, clear and complete instructions are very important. The great advantage of this new form of experiments is access to virtually unlimited pools of subjects. The most severe problem is control. Consequently, creative designs that provide controls or compensate for the lack of control are critical.

### 4.6.5. DESIGNATED USER LIST

Attached to every protocol and modifiable only by the Principle Author is a list of people who are authorized to use the protocol and the specific access permissions that each is given. As contemplated by various embodiments of the present invention, all users other than the Principle Author, regardless of their specific role or responsibilities in the project, are given the title of “Co-Author.”

What distinguishes the status of Co-Authors is the specific permissions given them by the Principle Author. The Principle Author automatically appears at the top of the list with full permissions and only the Principle Author can add users to the designated user list and assign them permissions. Examples of project staff members who will need to be added to the list of user include composers (programmers) and testers.

Sometimes a Principle Author will sketch out a study design and have someone else actually create the toolkit protocol. This person or persons will be added to the list of users.

Their title is Co-Author and their permissions will generally include View, Copy, Run, and Modify. On occasion, there will be separate “Testers.” They too must be added to the designated user list by the Principle Author as Co-Authors, but their permissions will generally be limited to Run and View.

At some point, the protocol is ready to implement. In some circumstances, the same people who composed the protocol will be the people who implement it, so they will already have the authorization to open and execute the protocol. In other circumstances, different people will actual conduct the sessions and so they will have to be accompanied by an authorized user or they will have to be added to the designated user list. If implementers need access to run a study, they generally will not require authority to View, Copy, and Modify the protocol and so only the Run box may be checked.

### 4.6.6. SECURITY TITLES

In preferred embodiments of the present invention three security titles are contemplated: Principle Author, Co-Authors, and Guests/Subjects.

The principle author adds co-authors to the designated user list and assigns the permissions appropriate to their security needs and responsibilities. Guests and Subjects are not generally on the designated user list. Instead, they are given limited access to Run a protocol from a special URL.

Unlike pre-toolkit days when there was a vast gulf between the researcher and the research software engineer, principle authors frequently maintain a hands-on relationship to the creation of the software and its implementation. This is what is meant by “research software created by and for researchers.” However, a principle author can give as many people access to a protocol as necessary with necessary permissions by adding people to the designated user list. Access is often required in multiple location studies where they are responsible for administration of the study in their locations.

### 4.6.7. LEVELS OF ACCESS TO PROTOCOLS (PERMISSIONS)

In preferred embodiments of the present invention six levels of access to a protocol are contemplated. These correspond to the permissions assigned a user in the designated user list.

If designated users are permitted to “Edit” the protocol, they are authorized to make changes in the original.

If designated users are permitted to “Edit Copy” the protocol, they are authorized to make a copy of it, see how it was set up, and modify it to fit their needs.

The “User” option allows the person with this permission to look at and modify the list of designated users.

The “results” option allows the permission holder to view the results of protocol runs—summary and individual sessions.

The “Cases” option breaks the results into cases.

The “Delete” option allows the principle author and only the principle author to delete an original protocol.

### 4.6.8. DATA SAFETY

Preferably, toolkits in accordance with the present invention have redundant back up systems in place to protect against data loss due to drive failure and other server related malfunctions. All data is routinely backed up on a nightly basis.

The toolkit may also provide additional protection independent of the server in the form of a local backup system that enables a user to save a copy of all information associated with a specific protocol in compressed and encrypted format on a local hard drive or storage device. If necessary, this information can be easily and completely restored to the toolkit database.

### 4.6.9. BACKUP AND RESTORE TOOLKIT PROTOCOL FILES

Preferably, the toolkit has a back up and restore feature that enables Authors and Co-Authors with appropriate permissions to create and download a compressed and encrypted zip file of any given protocol. If needed, this zip file can be uploaded to the server via the toolkit protocols interface back into the database thus replacing that protocol and an author/designer can restore both existing and deleted protocols.

Toolkits of the present invention preferably have a back up and restore feature that enables Authors and Co-Authors with appropriate permissions to create and download a compressed and encrypted zip file of any given protocol. If needed, this zip file can be uploaded to the server via the toolkit protocols interface back into the database thus replacing that protocol. Both existing and deleted protocols can be backed up.

To locally back up a protocol, an author/designer clicks on the Name of the protocol to be backed up, then on Backup in the User Action links. This brings up a Download File window where the download is initiated and saved under a name entered by the author/designer. The sole function of this file is to replace a protocol that has accidentally been deleted or unwanted changes were inadvertently saved.

To restore a saved protocol, an author/designer selects the option “Restore Protocol” in the User Action Menu and follows subsequent instructions.

### 4.7. SAVING RESULTS OF A TOOLKIT RUN

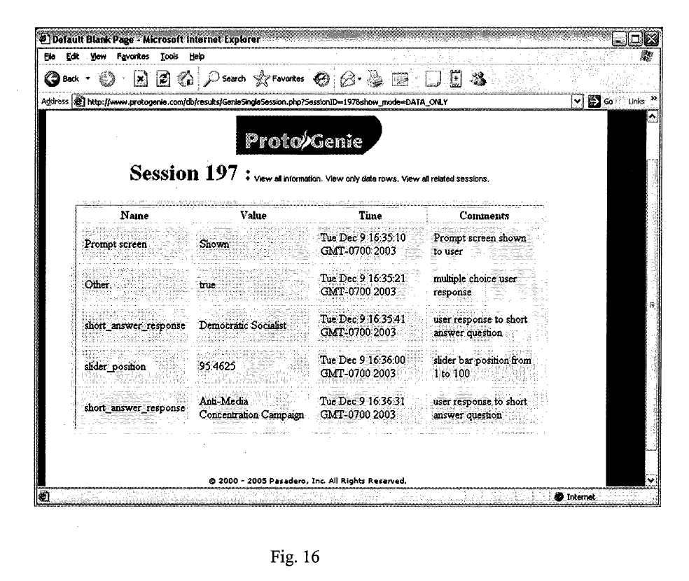

To save the results of the execution of a Toolkit protocol, an author/designer clicks on SAVE in the top menu of a Results Page, such as that illustrated in FIG. 16. The Session Results page is viewed under two circumstances. The first circumstance is at the completion of a normal execution of a protocol (when it was not executed from a run-time URL, as in an online survey). The second circumstance is by the selection of Results under the User Action menu, providing the Author/Designer has permission under the designated user list.

### 4.7.1. SESSION RESULTS DISPLAY OPTIONS

Session results can be shown as a “Choice of One Group” or “All Groups Together.” In the preferred embodiment, the Session Results display defaults to a Summary of all Sessions. This includes standard summary statistics, including means, standard deviations, and percentages. These summary statistics can be especially useful in exploratory experiments and other studies where the purpose is to make changes in the protocol based on feedback. To view a specific session, an author/designer clicks on the “View Single Session” option in the pulldown menu at the top right side of the session results page.

After a single session view of results is selected, results are presented with a choice of three formats: Plain Text, XML, and Comma Delimited.

Under the Change View of Data options, one can choose to view virtually everything recorded in the database for the selected session including the full text of instructions, questions, and answers, or to view an abbreviated presentation of the session results. The default view is the abbreviated view.

### 4.8. PORTING STUDY RESULTS TO A POPULAR STATISTICAL ANALYSIS PROGRAM

Most popular data analysis and spreadsheet software provide the capability to Import datasets with options for handling different formats. For example, Excel, StatView, SPSS, SAS, and JmpIn can input data in comma-delimited fields, which is one of the format options of the toolkit session results.

As presently exemplified, data must be imported from the toolkit Results one session at a time. Generally, speaking data files are organized such that rows are cases (subjects or sessions) and columns are variables. This is a simple process with programs such as Excel and other data analysis programs simply by transposing the data. Then, the results for each session can be added as rows in the data table.

### 5.0. TOOLKIT BENEFITS

Accordingly, toolkits in accordance with the present invention provide universal, reusable access, friendly interfaces, reusable protocols, and Webcentric-open system architecture paving the way for innovative applications. As should be apparent, some may be done as development projects involving the construction of protocol libraries and new features for the toolkit where necessary. Among the many projects contemplated are product testing and evaluation, dynamic graphical display generators, and clinical diagnosis. These applications raise unique problems, many of which will be solved by students and other users with special interests in computer support technology. Product Testing & Evaluation

Moreover, the flood of new and modified products (software and hardware) come on the world's market every year, most of which make extravagant claims about what they are going to do and claims that they can do it better than other products or brands. Unfortunately, unless done by regulatory agencies out of concern for safety, there is precious little testing of these claims. One explanation for this phenomenon is the ineffectiveness of public demand. But, many producers would voluntarily conduct tests if there were convenient, effective, and inexpensive testing technologies these technologies can be developed and implemented by the toolkit.

For example, product performance testing often involves the external attributes or properties of a product. Criteria generally include adequacy, flexibility, “feel,” usability, cost, effectiveness, speed, responsiveness, reliability, support, documentation, compatibility, and other. In some cases, criteria might be subjective with qualitative measurement. In other cases, criteria might be objective with quantitative (metrics) measurement. Testing may involve one product or the comparison of two or more. Performance testing can be done by one evaluator (expert) or by a panel of experts (judges). Performance testing can be done as part of pre-release, beta, and market preparation processes or anytime in the lifetime of the product. Similarly, performance testing with the toolkit allows the focus of evaluation to be on the changing of technologies behind products rather than external attributes of the products.

Toolkits in accordance with the present invention are unique for their implementation completely on the Internet, becoming the first extensive online authoring tool for creating research software. This innovation is significant because the technology for implementing large applications online is still in its infancy and many problems had to be solved. Among the practical consequences of the online application is that it enabled an open-source environment in which researchers could create the authoring system itself. Researchers can write their own applications using the system and they can access the system virtually anywhere and on any computer with an Internet connection.

Moreover, such toolkits are unique because they are built on the principle of “renewable software,” which holds that research software should never be used once and thrown away. In the toolkit environment, new research software is archived and used again in whole or in part as templates for new research. In essence, research software once built is a capital asset rather than an expense.

Additionally, because research software can be built by non-programmers using the toolkit, the costs in time and money for high-priced software engineers and programmers are virtually eliminated, thereby dramatically reducing the cost of building research software.

By the very nature of the Internet, toolkits in accordance with the present invention foster the decentralization of research and encourages research by small organizations and projects with small budgets. Among other implications, federal research funding agencies and ultimately the public should be major benefactors of the toolkit through the reduction of the budgets of funded organizations.

The user interface of toolkits in accordance with the present invention is unique because it is designed by the researcher-developers to meld the logic of research with the familiar look and feel of the Web. Simplicity makes it useable at all levels of technical skills and age groups, including use in science education at all levels.

The online sharing foundations of such toolkits stimulate a new kind of global research environment in which communities of researchers share research problems, designs, software, and results online. Cross-national interactions and communications are facilitated by the fact that special applications of the toolkit do not have to be created for non-English speaking countries.

Online access and ease of use support departmental and programmatic applications, such as campus computer support programs, scientific method curricula, programs for people with disabilities, global conference rooms, and online governance and virtual management.

Other benefits of the online application include the liberation of researchers from expensive shrink-wrapped applications and irritating and distracting maintenance and upgrades. It provides universal access independent of equipment and operating systems. It provides a standard and familiar user interface consistent with the language of research. It provides for an integrated research-centered forum and an integrated help system. Finally, by the very nature of the Internet, implementation online fosters the decentralization of research and encourages small science as a remedy to “big science.”

Thus, as toolkit use expands, it evolves. Preferably extending support to all empirical research, evaluation research, and practitioner support systems, such as diagnostic systems. In many cases, extending support only involves the development of collections of protocols that are representative of the field along with some changes in terminology.

In other cases, extending support requires new features and options in the toolkit Editor, which can be made with the toolkit's Web-based and open source architecture. Support for empirical research methods will include archival research, industrial research, case studies, single subject research, longitudinal and cohort research.

Evaluation research includes product and program evaluation. Decision support systems include process simulations, workflow systems, expert systems, and diagnostic systems. Also, the toolkit will be applied in organizations in departmental and programmatic ways, as for example, to support a campus social science computing laboratory.

Additionally, online accessibility makes widespread use possible in other countries. There are also cost-savings, wide utility, and easy access to the toolkit services in publications available to government research agencies and funding agencies that adopt the toolkit, recommend its use, or bring it to the attention of researchers.

I claim:

1. An online protocol authoring and execution system for processing data, comprising:
a tool development process;
a protocol design process;
a protocol execution process;
a data analysis process;
a protocol storage process;
a protocol retrieval process;
a data storage process; and
a data retrieval process.

2. The online system for processing data of claim 1,
wherein an author enters data into said tool development process, wherein data leaving said tool development process enters said protocol design process, and wherein protocol design process feedback from said protocol design process returns to said tool development process; and
wherein data leaving said protocol design process is configured as at least one protocol and said protocol storage process stores said at least one protocol in a protocol archive, wherein protocol output feedback from said at least one protocol is provided to said protocol design process; and
wherein said protocol execution process accesses said at least one protocol through said protocol retrieval process, wherein said protocol execution process provides protocol execution feedback to said protocol design process and to said tool development process; and
wherein data leaving said protocol execution process is configured as research data, and
wherein a data storage process stores said research data in a data archive; and
wherein said data analysis process accesses said research data through a data retrieval process from said data archive.

3. The online system for processing data of claim 2, wherein said protocol design process comprises a web-based protocol composer.

4. The online system for processing data of claim 2, wherein said protocol execution process comprises a web-based protocol executable.

5. The online system for processing data of claim 2, said data analysis process visually presents said research data.

6. The online system for processing data of claim 2, wherein said protocol execution feedback is a template design protocol.

7. The online system for processing data of claim 6, wherein said template design protocol is available to third parties.

8. An online protocol processing program, comprising:
a web-based protocol composer for generating a data processing protocol and a protocol database for storing said protocol;
a data collector for collecting input data entered via an internet based research instrument;
a protocol executable for processing said data in accordance with said data processing protocol and outputting protocol data;
a database for storing at least one of said data and said protocol data; and
a protocol data display for displaying protocol data.

9. The online system of claim 8, wherein said web-based protocol composer is a graphical user interface.

10. The online system of claim 8, wherein said protocol data display further displays input data.

11. The online system of claim 8, wherein said protocol data is displayed in standard database format.

12. The online system of claim 8, wherein said protocol data is displayed is displayed in at least one table format.

13. The online system of claim 8, wherein said data processing protocol is made available to third parties.

14. The online system of claim 13, wherein said data processing protocol is made available to third parties at the option of a user.

15. The online system of claim 13, wherein said data processing protocol is automatically made available to third parties.

16. The online system of claim 13, wherein said data processing protocol is made available to third parties over the internet.
